(19) United States
(12) Patent Application Publication
(10) Pub. No.: US 2017/0053075 A1
(43) Pub. Date: Feb. 23, 2017

(54) SYSTEM AND METHOD FOR CREATION OF EVIDENCE-INFORMED CASE RATE BUDGETS FOR BUNDLED PAYMENTS

(71) Applicant: HEALTH CARE INCENTIVES IMPROVEMENT INSTITUTE, INC., Newtown, CT (US)

(72) Inventors: Michael MOSES, Upper Marlbroro, MD (US); Warren MCGUIRE, Shelton, CT (US); Quinn COLDIRON, Gretna, NE (US); Sarah BURSTEIN, Newton, PA (US); Elizabeth BAILEY, Midland, MI (US); Andrew WILSON, Somerville, MA (US); Amita RASTOGI, Munster, IN (US); Lawrence MOSLEY, Doyline, LA (US); Francois DE BRANTES, Newtown, CT (US); Jenna SLUSARZ, Amherst, NH (US)

(21) Appl. No.: 15/239,604

(22) Filed: Aug. 17, 2016

Related U.S. Application Data
(60) Provisional application No. 62/205,985, filed on Aug. 17, 2015.

(51) Int. Cl. G06F 19/00; G06Q 20/10

(52) U.S. Cl. CPC G06F 19/328; G06Q 20/102

(57) ABSTRACT

The invention provides a computer implemented method for constructing a patient-specific evidence-informed case rate (ECR) for an episode of medical care spanning a defined period of time for a particular payer-provider-patient triad to create a patient-specific, severity adjusted prospective budget for the patient. ECR Analytics is a tool that constructs episodes of care using administrative claims data, both medical and pharmacy. It calculates the cost of care of patient-specific episodes by assigning relevant services to each episode and further distinguishing those services as typical or routine versus those associated with a complication. The episodes calculated within ECR Analytics can be attributed to specific providers, risk adjusted for performance measurement, and can also be used to construct prospective budgets for payment purposes, such as episode of care payment or reference pricing.

### CROSS REFERENCE TO RELATED APPLICATIONS

This application claims the benefit of U.S. Provisional Application No. 62/205,985 filed Aug. 17, 2015. The entire disclosure of the prior application is hereby incorporated by reference in its entirety.

### FIELD OF THE INVENTION

The present disclosure generally relates to systems and methods for bundled healthcare pricing, and more specifically, to systems and methods that enable the creation of a bundled price for a severity-adjusted episode of care.

### BACKGROUND

The flaws of the traditional fee-for-service and capitation systems are well known. Fee-for-service, which involves separate payments for each service, has been closely associated with the rapid increase of health insurance premiums, while capitation, which provides a flat fee per patient, can put providers at risk by providing insufficient funds to cover the cost of services rendered. In the United States, both systems have failed to systematically promote coordination among providers or high-quality outcomes for patients.

Bundled payments have become known as a “middle ground” between fee-for-service reimbursement and capitation. Bundled payments are the reimbursement of healthcare providers on the basis of expected costs for clinically defined episodes of care. Bundled payments ask providers to assume financial risk for the cost of services for a particular treatment or condition, as well as costs associated with preventable complications. Payments are made to the provider on the basis of expected costs for clinically defined episodes that may involve several practitioner types, settings of care, and services or procedures over time.

Most bundled payment models are “retrospective,” meaning payers pay providers after they have delivered the care. From a transitional perspective, this makes it possible to build a bundled payment on a fee-for-service base then adjusting as necessary when the episode is over, but this also means that the inflationary incentives inherent in fee-for-service are part of the mix. It would be desirable to pay providers their bundled payments prospectively, making upward or downward adjustments at the end for outliers, quality lapses, and other factors. For the foregoing reasons there is a need for a method that will prospectively define a budget for one or more specified episodes of care, and to adjust said budgets for the severity of patients and other contracting terms. Further, when episodes of care are clinically associable to one another, then prospective budgets for the combination of those episodes should be defined in toto to ensure that providers work collaboratively to deliver all the services that are clinically relevant for the care of the associated medical episodes. Such a payment construct can encourage the coordination of clinically related services in a patient-centric manner, and can be adjusted to the severity of the patient's conditions.

### SUMMARY OF THE INVENTION

The present invention provides an evidence-informed case rate (ECR) Analytics tool and method of creating patient-specific episodes of medical care that span a defined period of time for a particular payer-provider-patient triad. These episodes are analyzed, and a patient-specific ECR budget is generated based on each underlying condition, illness or injury, and its comorbidities and risk factors. This ECR budget can then be used for a variety of purposes such as in value-based payment models, and performance evaluation to improve the quality of care and patient outcomes.

In accordance with the invention, there is provided an evidence-informed case rate (ECR) Analytics tool that constructs episodes of care using administrative claims data, both medical and pharmacy, and calculates the cost of care of patient-specific episodes by assigning relevant services to each episode and further distinguishing those services as typical or routine versus those associated with a complication. Patients can have as many episodes as are defined within ECR Analytics; it is a true episode system, built around the patient, in which clinically related episodes are associated to one another.

The present invention also provides a system and method of creating prospective budgets for payment purposes, such as episode of care payment or reference pricing, by using the episodes calculated within ECR Analytics that are then attributed to specific providers, and risk adjusted for performance measurement, to construct prospective budgets.

ECR Analytics separates costs of typical care from costs associated with potentially avoidable complications (PACs). PACs, at the core, are events that negatively impact patients and are controllable by providers. Prospective ECR budgets created by the ECR Analytics include an allowance for PACs, which can act as an incentive to improve quality of care, clinical collaboration, and reduce unwarranted costs. The separation of PAC versus typical costs also allows for performance comparisons of providers, as a high PAC rate can be an indicator of low quality whereas a low PAC rate can be associated to high quality care. Complications can be a significant source of variation in cost, so by identifying them, it enables the creation of a plan to decrease overall costs while improving the quality of care. In an embodiment, ECR Analytics also comprises an overarching clinical logic in which episodes are associated with one another. This overarching clinical logic allows a member to have multiple open episodes that may coexist concurrently and can be related through clinical associations. This allows inferences about costs of care at many different levels, and contracting at different levels of accountability. Further, while most analytical systems typically have static rules, the ECR Analytics allows for flexibility and parameter changes within episodes. This permits for accurate customization within the specific dataset to fit user needs based on what the analysis is being used for (e.g. bundled payments, cost and quality analysis).

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

These and other features, aspects, and advantages of the present invention will become better understood with regard to the following description, appended claims, and accompanying drawings where:

FIG. 1 is a flow chart of the overall process of conducting ECR Analytics in accordance with embodiments of the present invention.

FIG. 2 is an ECR Analytics Process Flow Diagram illustrating the process of conducting ECR Analytics and the ensuing budget creation process in accordance with embodiments of the present invention.

FIG. 3 is a flow chart illustrating the process of the process of data input and associated matching against Episode of Care definitions in accordance with embodiments of the present invention.

FIG. 4 is diagram illustrating an example of the levels of association of episodes a hypothetical patient experienced over the course of one year.

FIGS. 5A, 5B, 5C, 5D, 5E, 5F, 5G, 5H and 5I are nine parts of one flow chart illustrating the process of creating episode association levels in accordance with an embodiment of the present invention.

FIGS. 6A, 6B, 6C, 6D, 6E, 6F, and 6G are seven parts of one flow chart illustrating the process of triggering the existence of an episode in accordance with an embodiment of the present invention.

FIGS. 7A, 7B, 7C, and 7D are four parts of one flow chart illustrating the process of assigning services, other than the ones covered by the inpatient facility services, to episodes in accordance with an embodiment of the present invention.

FIGS. 8A, 8B, 8C, 8D, 8E and 8F are six parts of one is a flow chart illustrating the process of assigning inpatient facility services, to episodes in accordance with an embodiment of the present invention.

FIGS. 9A, 9B, 9C, 9D, 9E, 9F, 9G, 9H, 9I, 9J, 9K, 9L, 9M and 9N are 14 parts of one is a flow chart illustrating the process of attributing episodes to providers in accordance with an embodiment of the present invention.

FIGS. 10A and 10B are two parts of one flow chart illustrating the process of generating a budget from inputted data in accordance with an embodiment of the present invention.

### DETAILED DESCRIPTION

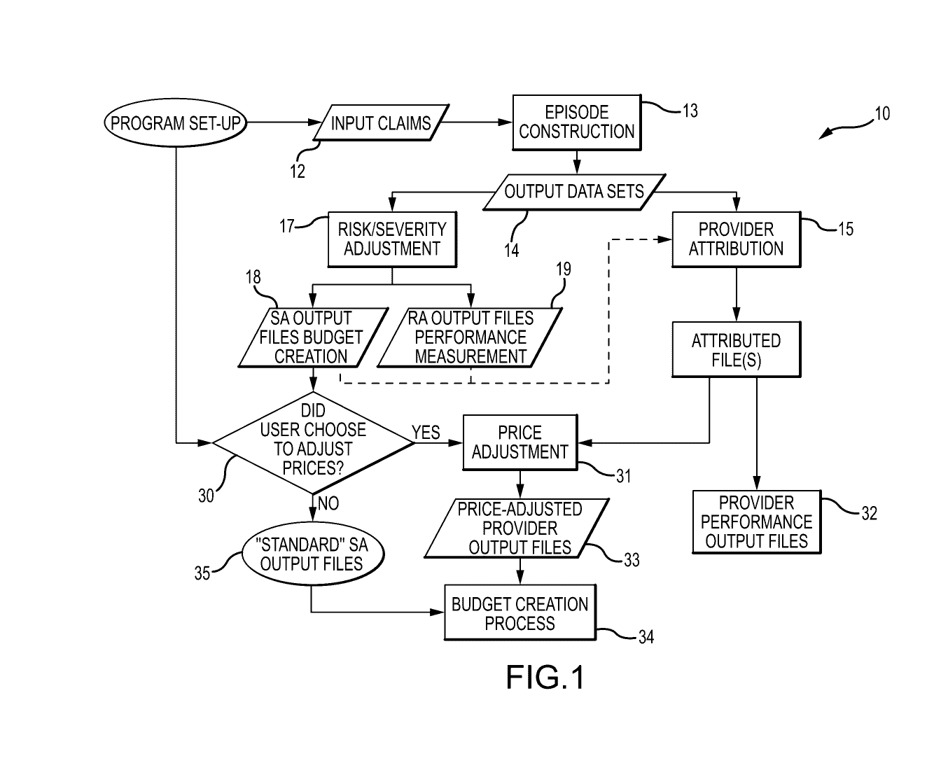

Referring now to FIG. 1, therein illustrated is a high-level process map indicating the order of operations performed by an embodiment of the ECR Analytics 10. ECR analytics can be used in conjunction with the invention described in U.S. Ser. No. 14/446,670 “Episode of Care Builder Method and System” filed on Jul. 30, 2014, herein incorporated by reference in its entirety.

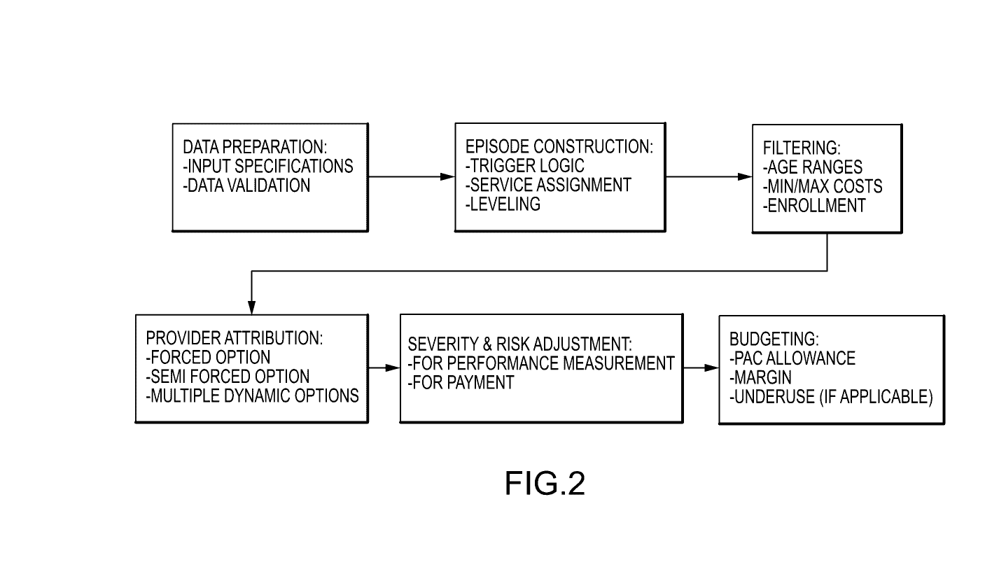

FIG. 2 shows an overview of embodiments of the invention. To create a budget, after data is provided 1) episodes are constructed, 2) filtering is performed to ensure that only complete episodes and those relevant to the population are analyzed, 3) episodes are attributed to a specific provider; 4) a severity and risk adjustment step is performed to allow for the calculation of fair and credible expected costs and 5) a prospective budget is created.

### Program Set-Up

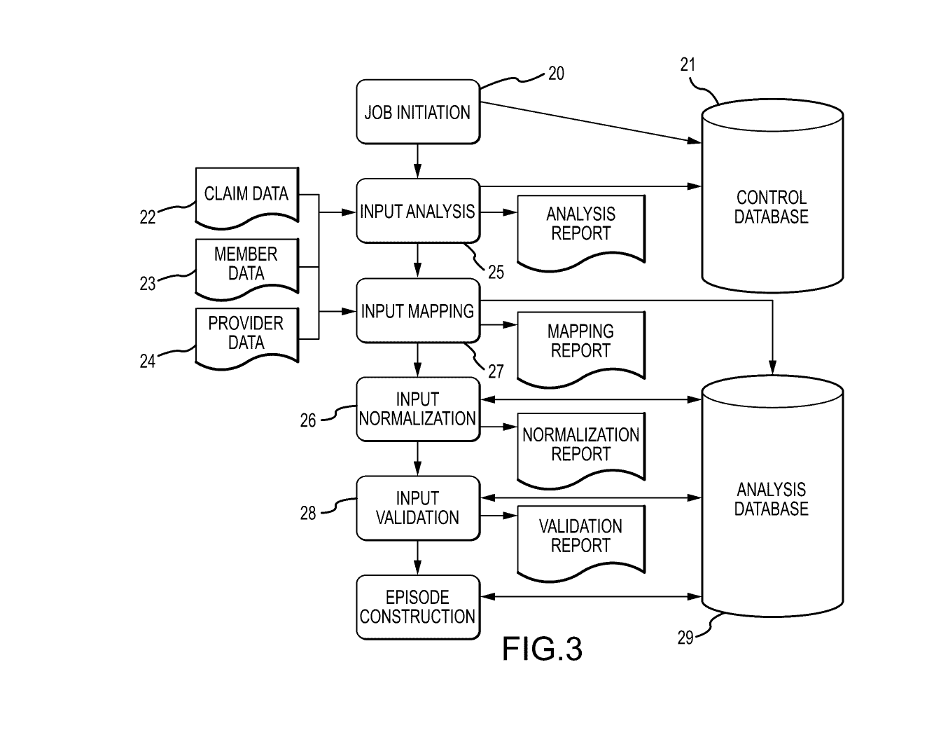

The ECR Analytics 10 begins with a program set-up step where, as shown, for example in FIG. 3, there is job initiation 20 where a job is created to handle a given set of inputs from a user. Parameters for the job may be established at this time or deferred until subsequent steps. These job parameters are stored in the control database 21. ECR metadata are also imported into ECR Analytics.

### Input Claims

Still referring to FIG. 3 there is an input of data such as claims data 22, member data 23, and provider data 24. There is then input analysis 25 where the raw input is analyzed for completeness. Some preliminary summarization and input mapping 27 may take place and reports may be generated to determine whether the data should be passed along to the next step in the process. The analysis results are stored in the control database 21. Next there is input normalization 26 where the raw input is restructured to fit units of pre-established data. For example, this may include merging of claim records into final versions, roll-up of inpatient services into a single record, and concatenation of any sequential enrollment records that might emanate from a submitter's system. Finally, the input validation step 28 provides a series of reports that help determine things such as whether the data should be passed along to the next step, or reacquired with submitter modifications, or possibly cleansed of anomalies. Once completed, the control database will contain valid, transformed input. In an embodiment of the ECR Analytics 10 of FIG. 1 this would be all under the input claims 12 step.

Referring back to FIG. 3 once episode construction is complete, the analysis database 29 will contain all triggered episodes and ancillary tables to feed subsequent analysis modules. This is similarly indicated as output data sets 14 in FIG. 1. The output data sets 14 may then be used as input for provider attribution 15. The output data sets 14 may also be used as input for risk/severity adjustment 17.

The present invention provides a tool for constructing episodes of care (ECR analytics) which defined episodes can be used to create prospective budgets. ECR (Evidence-informed Case Rate) Analytics is a tool that constructs episodes of care using administrative claims data, both medical and pharmacy. It calculates the cost of care of patient-specific episodes by assigning relevant services to each episode and further distinguishing those services as typical or routine versus those associated with a complication. Patients can have as many episodes as are defined within ECR Analytics; it is a true episode system, built around the patient, in which clinically related episodes are associated to one another. In accordance with the invention, the episodes calculated within ECR Analytics can be attributed to specific providers, risk adjusted for performance measurement, and can also be used to construct prospective budgets for payment purposes, such as episode of care payment or reference pricing.

An Evidence-informed Case Rate (ECR) is an episode of medical care that spans a defined period of time for a particular payer-provider-patient triad, as informed by clinical practice guidelines and/or expert opinion. The ECR starts after there is a confirmed trigger for that episode (e.g. a diagnosis). An ECR is developed based on the quantity and types of services needed for the treatment of a typical episode of care and is severity adjusted based on patient characteristics, provider characteristics, and geographical factors. The Business Rules are based on the following ECR types: Chronic Condition, Acute Medical, Procedural, Other Condition and System Related Failure (SRF).

As noted above, ECRs are constructed person-by-person. ECR episode construction has two phases: (1) Episode identification determines what episodes exist during the period under consideration, and when they start and end; (2) Service assignment determines episode(s) to which each service is assigned, and whether they are typical for each episode, or a complication.

Most episodes are condition-related. ECRs are grouped into four categories: 1) Chronic Condition—care for a chronic medical condition; 2) Acute Medical—care for an acute medical condition; 3) Procedural (Inpatient (IP) or Outpatient (OP))—a major procedure and its follow-up care; the procedure may treat a chronic or acute condition; and 4) Other Condition—care for pregnancy and cancer episodes. In addition, there is a generic episode type: System-related Failures—Inpatient and follow-up care for a condition caused by a systemic patient-safety failure.

The following terms and definitions are provided to assist the reader and provide context and example. One skilled in the art recognizes that the definitions provided herein may not necessarily be inclusive of all possible alternatives. Likewise, other terms and phrases may be used in the art, but have the same definitions provided herein.

“Current Procedural Terminology” (CPT) code set is a medical code set maintained by the American Medical Association through the CPT Editorial Panel.

“National Drug Code” (NDC) is a unique product identifier used in the United States for drugs intended for human use.

“Diagnosis-related group” (DRG) is a system to classify hospital cases into one of originally 467 groups.

“Evidence-informed Case Rate” (ECR) is a patient-specific episode of medical care that spans a defined period of time for a particular payer-provider-patient triad. For each ECR, the ECR Analytics will automatically calculate patient-specific ECR predicted budgets based on underlying conditions, comorbidities and risk factors. The risk-adjusted allowance for the prospective budget will include the expected costs of Typical Services, the expected costs of Potentially Avoidable Complications (PACs), the PAC Allowance, the PAC Reduction Target, the margin, and the underuse adjustment. For each ECR, the ECR Analytics will accumulate dollars for services categorized as Typical, Typical with Complication, and Complication (PAC) services as defined in the ECR Metadata.

“ECR metadata” are series of diagnosis, procedure, and pharmacy code tables that serve as the foundation of the episode. The ECR metadata consist of information such as parameters, trigger codes, typical diagnosis codes, typical procedure codes, core services, complication codes, associations, risk factors, subtypes, and pharmacy codes. These files are provided for all ECRs.

“Trigger and Time Windows”—a trigger initiates an ECR based on diagnosis and/or procedure codes found on institutional or non-institutional claims data. A Trigger code assigns a time window for the start and end dates of each ECR (depending on the ECR Type): Chronic Condition ECRs, Acute medical ECRs, Procedural ECRs (both inpatient and outpatient), Other Condition ECRs and System-Related Failure (SRF).

Chronic Condition ECRs: Chronic Condition ECRs can either be triggered by a trigger diagnosis code in the principal position on an Inpatient claim, a trigger diagnosis code in any position on an Outpatient Facility claim containing an E&M code in any position, or a trigger diagnosis code in any position on a Professional E&M service with a confirming claim. The confirming claim for the Professional trigger must occur a specific time period apart from the initial trigger claim and can come in the form of an Inpatient, Outpatient Facility or subsequent Professional claim meeting the same criteria outlined above. Additionally, some Chronic Condition ECRs can also be triggered by the presence of other episodes alone or other episodes with a confirming claim. For example, both CAD and CHF can be triggered by AMI, PCI or CxCABG. If triggered by 2 claims, the start date of the episode is determined using the date of the first trigger. Chronic Condition episodes are often the episodes with which other episodes are associated.

Acute medical ECRs: Acute Medical ECRs, such as AMI, Stroke, and Hip/Pelvic Fracture are triggered by 1 inpatient stay claim with a principal diagnosis trigger code. Pneumonia and URI ECRs can also be triggered by Outpatient Facility or Professional claims. The time window for Acute Medical ECRs is usually 30 days from the trigger event date or 30 days post-discharge if it is an inpatient stay, but may vary. If the episode requires a confirming claim to trigger, the time window is set according to the date of the first trigger. Acute Medical episodes that are defined as complications for one or more episodes will be associated with those episodes as Complications (PACs).

Procedural ECRs (both inpatient and outpatient): Procedural ECRs are triggered by a variety of episode-specific trigger rules, which are detailed in Chapter 3, Section II Trigger Events. The time window is usually 30 days prior to the trigger and 90 days post discharge. However, this can vary by episode. Procedures are most often triggered to treat a particular symptom or condition and associated back to the conditions for which they are a treatment.

Other Condition ECRs: Other Condition ECRs are most often triggered by the presence of another episode, usually a procedure. For example, Pregnancy is triggered by either a C Section episode or a Vaginal Delivery episode. Breast Cancer is triggered by Mastectomy with a confirming claim.

System-Related Failure (SRF): System-related failure episodes are triggered by 1 inpatient service with a principal diagnosis code of a system-related failure. Their time window is their length of stay (admission through discharge) plus a 30 day look forward window. Sick Care episodes are also classified as SRF episodes, but are triggered by 1 outpatient or professional service and remain open for 90 days. Inpatient SRF episodes may be associated back to the Sick Care episode.

“Trigger event” is a service (or, in some cases a set of services) with characteristics that are indicative of the presence of a condition or procedure. Characteristics that define a trigger event include the diagnosis and/or procedure codes on the claim(s), and other attributes of the service(s) such as place or type of service, or provider type. When more than one service is required, their relationship in time may be considered.

“Typical” includes the set of evidence-informed core services plus additional services that may be discretionary but related to care for a given ECR. The services are derived from the codes when present on a patient claim and are then assigned to an ECR. Typical services are defined through the ECR Metadata.

“Potentially Avoidable Complications” (PAC) are defined through the ECR metadata tables. It is a potentially preventable cost identified by diagnosis codes on institutional or professional claims; when PAC codes appear on a claim, costs for those services are counted as PACs.

“PAC Allowance” is a percentage negotiated by the payer and provider, which is applied to the expected cost of complications. By setting a PAC Allowance of less than 100%, the payer and provider agree that the overall budget calculation will include a percentage reduction in the expected cost of complications. For example, if the PAC Allowance is set at 75%, only 75% of the expected cost of complications would be built back into the overall budget.

“PAC Reduction Target” is a percentage negotiated by the payer and provider, by which the provider agrees to reduce PACs. In effect, the payer and provider negotiate a reduction in PACs in order for any incentive payment arrangement to take place. For example, the PAC Allowance could be set at 100% but an incentive payment could be contingent upon a 15% reduction in PACs.

### ECR Metadata Description

The boundaries of each ECR are conveyed in the form of ECR metadata, which are imported into ECR Analytics. ECR metadata are series of diagnosis, procedure, and pharmacy code tables that serve as the foundation of the episode. The ECR metadata consist of parameters, trigger codes, typical diagnosis codes, typical procedure codes, core services, complication codes, associations, risk factors, subtypes, and pharmacy codes.

Parameters within the ECR metadata file determine the episode time window and trigger logic for each ECR. The trigger code list contains diagnosis and/or procedure codes that, when coupled with the trigger logic, provide a strong enough signal to open up an episode of care. The typical diagnosis and typical procedure code lists consist of diagnosis and procedure codes, respectively, and determine whether a service is potentially relevant to an episode. The service assignment logic, described in more detail under episode construction, is applied to the claims with relevant diagnosis and/or procedure codes and ultimately dictates whether a service is relevant to an episode. Core services are a subset of typical procedure codes that are considered to be essential for the routine management of certain condition episodes. Complication codes are diagnosis codes that indicate either an acute exacerbation of the underlying condition or procedure or a patient safety failure. The ECR metadata also includes a list of episodes that are clinically related to one another and how they should be associated—this logic is described in more detail under episode construction. Universal list of risk factors is applied to all episodes of care for severity adjustment purposes, whereas specific subtypes are defined for each individual episode—subtype indicate differences in severity markers for episodes. Risk factors and subtypes are described in more detail under severity adjustment. Lastly pharmacy code lists indicate relevant medications for each episode of care.

### Episode Construction Logic

### I. Episode Construction Rules

Each episode type has a set of parameters that define its core construction. For example, each episode type (i.e. chronic condition, acute medical, procedural, other condition or system related failure) has a trigger event, an episode window (establishes the start and end dates) and associations (identifies episodes with a close clinical relationship), for which a consolidated view will be constructed.

### Episode Construction

Referring to FIG. 1 following the input claims 12 step is episode construction 13. This step performs the actual matching of the validated and transformed data against Episode of Care definitions. Each episode type has a set of parameters that defines its core construction. ECR episode construction generally has two phases: (1) Episode identification determines what episodes exist during the period under consideration, and when they start and end; and (2) Service assignment (discussed below) determines episode(s) to which each service is assigned, and whether they are typical for each episode, or a complication.

Episode Identification

Trigger events indicate the existence of episodes. For all episode types except Procedural, once an episode is open, a claim with a trigger code will be assigned according to the routine assignment rules and not used to trigger another identical episode. New procedural episodes can be triggered for the same ECR as long as the trigger service does not overlap with the previous trigger service.

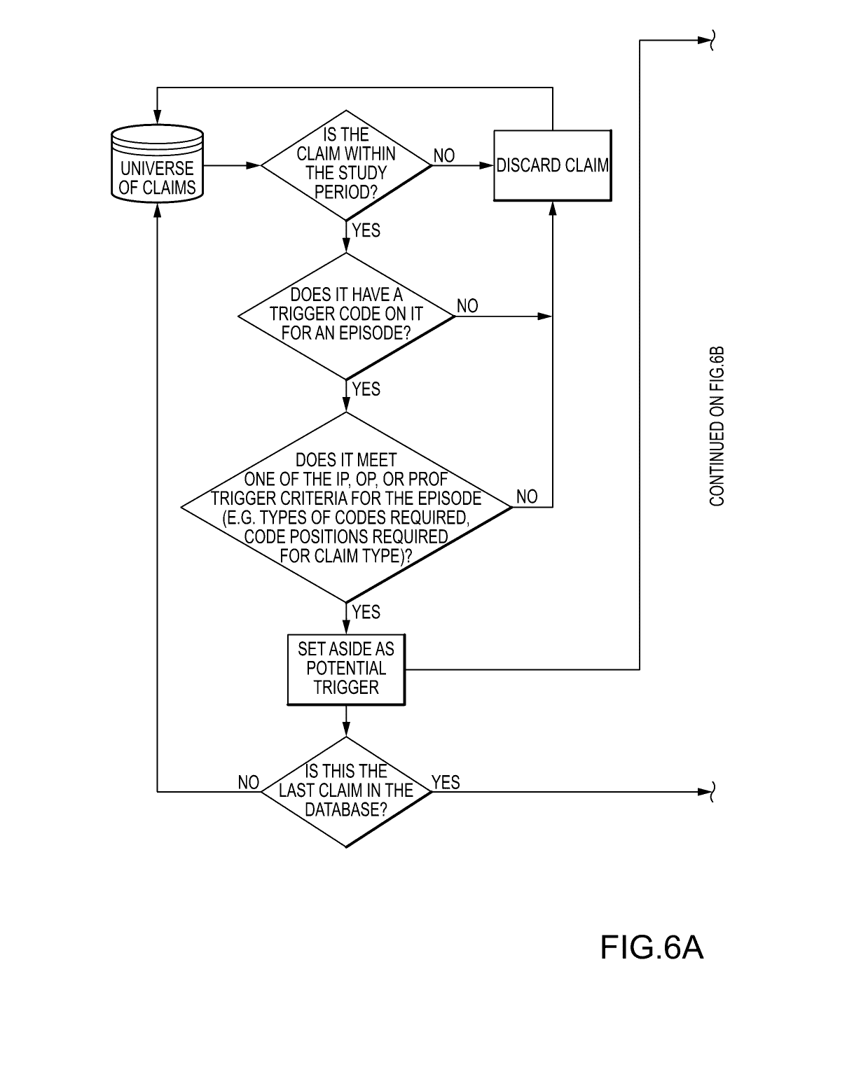

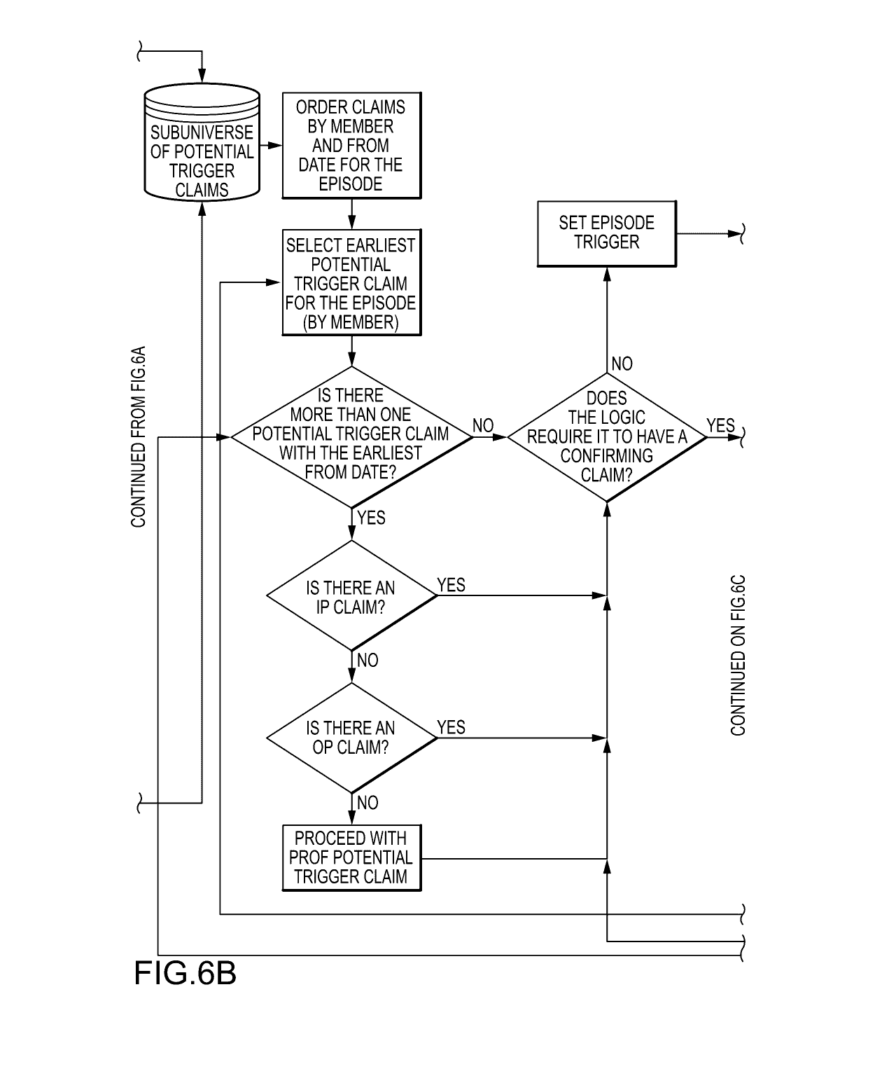

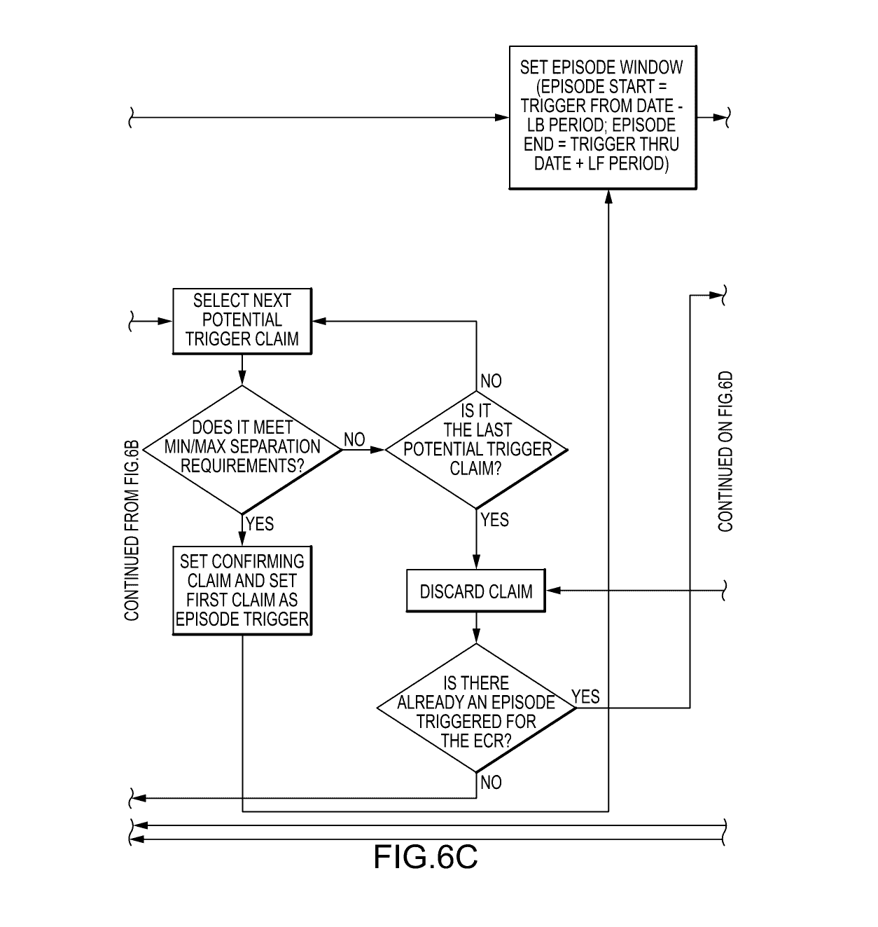

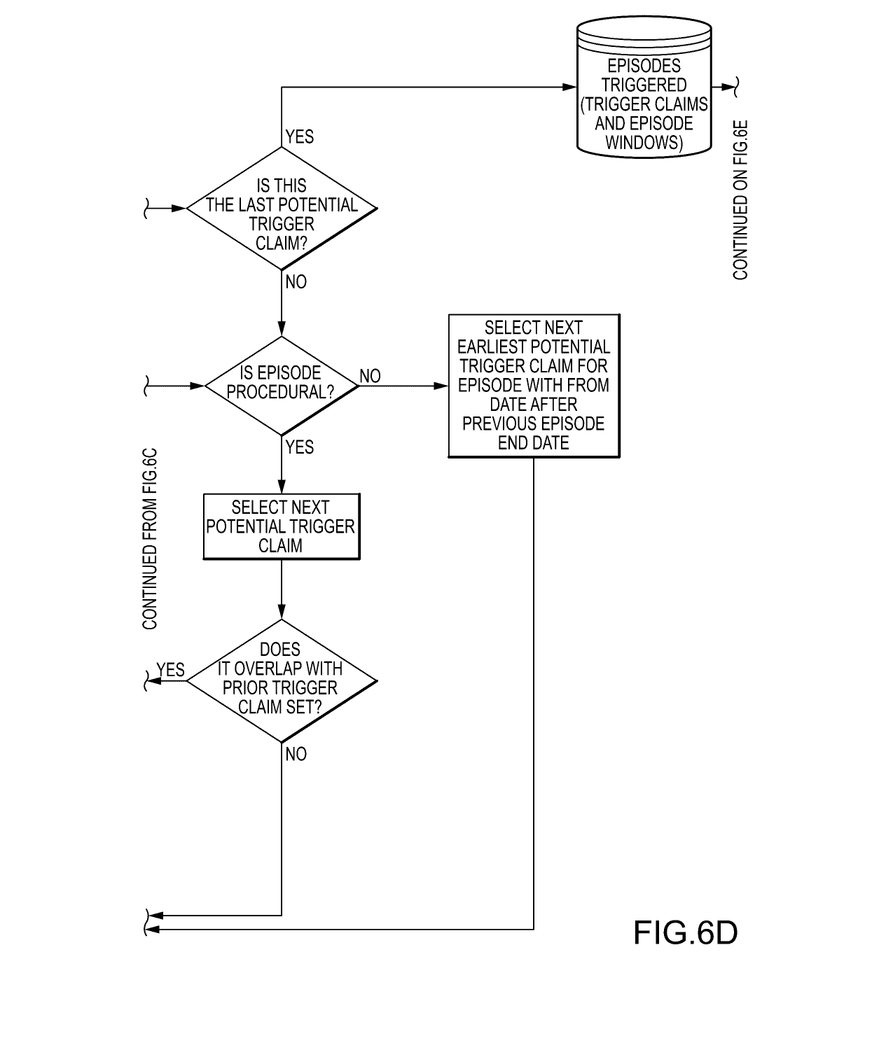

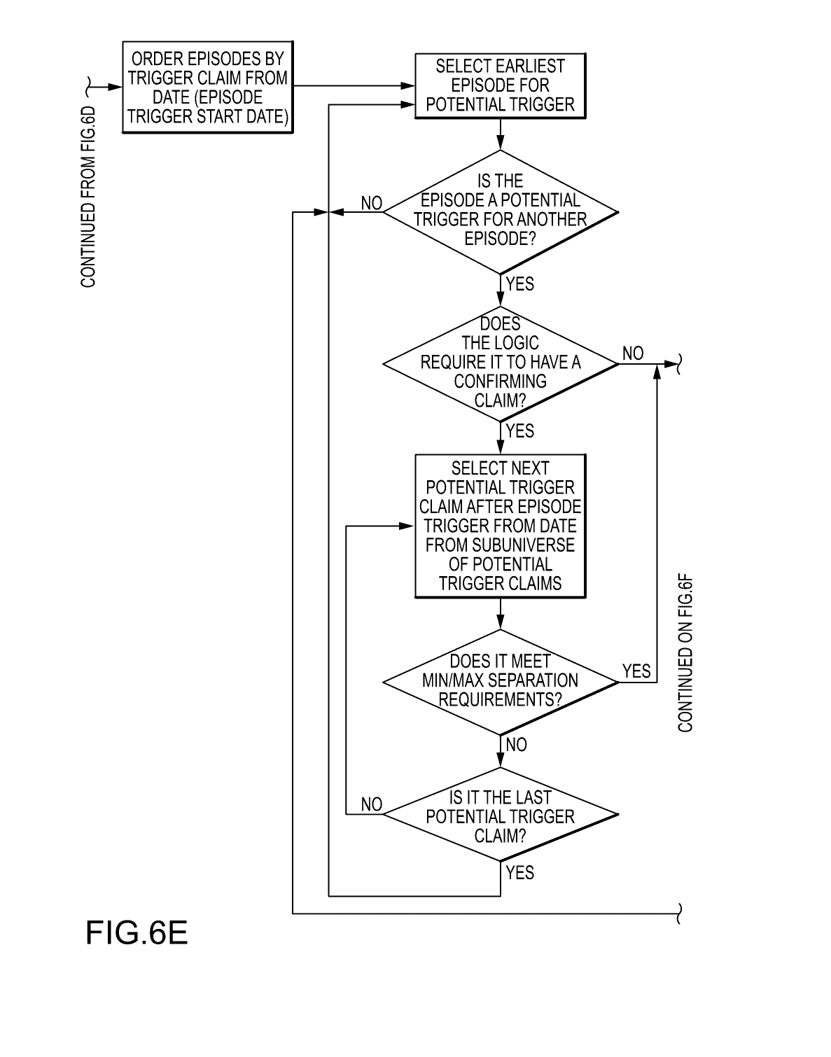

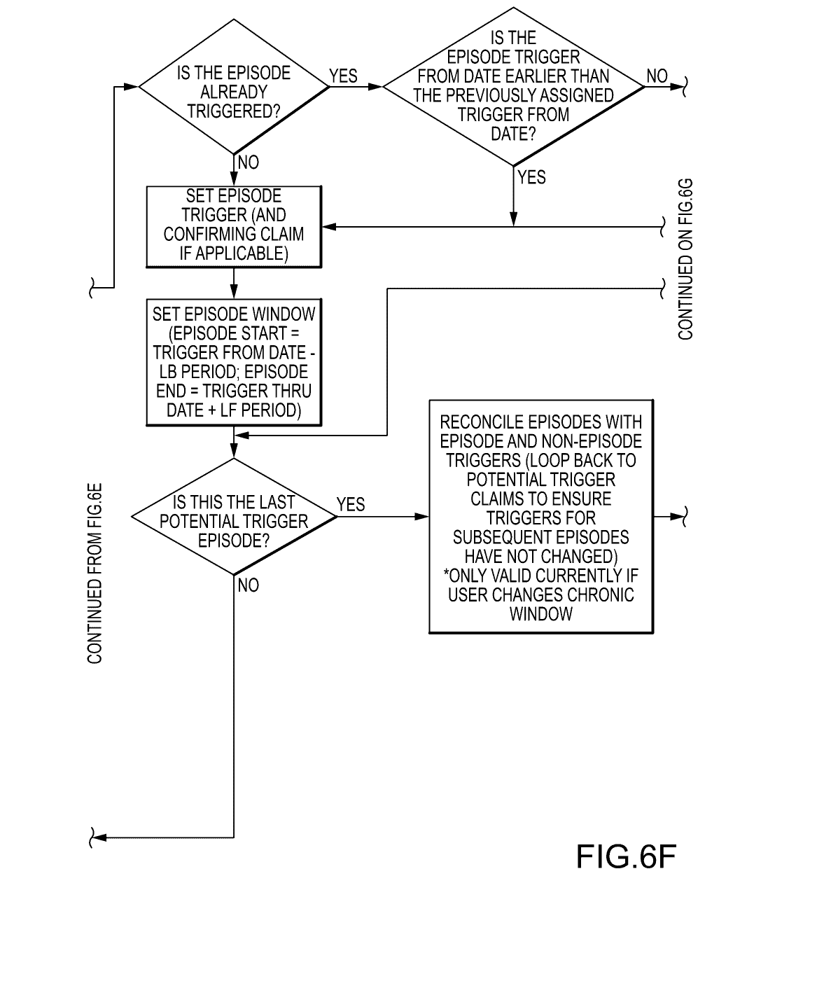

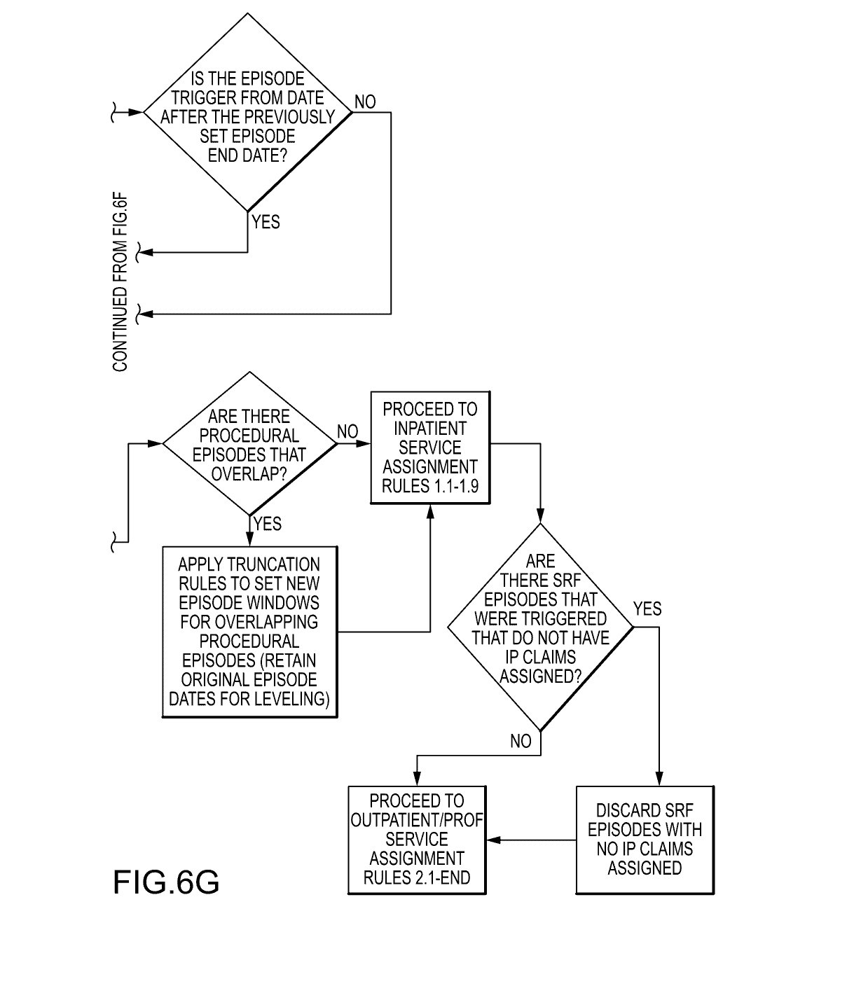

Episodes can be triggered by a combination of other episodes, Inpatient/Outpatient Facility and/or Professional services, procedure and/or diagnosis codes in the principal and/or any position. Inpatient facility triggers should come only from short-term acute care or psychiatric facilities. In instances where an episode must be triggered by two services or another episode and a service, the timeframe for the separation of those services is provided. FIGS. 6A-6G provide a process map that illustrates an example of the trigger logic.

The start date for an episode is the first date of its trigger event, less the number of days in the look-back period if applicable. The end date of an episode is the trigger event end date plus the number of days in the look-forward period. Default look-back periods and episode lengths for each episode are given in the ECR metadata. The basic calculations for episode time windows are subject to the following modifications: date of death and procedural truncation, but the original episode start and end dates are retained and used during Leveling/Association of episodes.

### II. Trigger Events

Trigger events indicate the existence of episodes. A trigger event is a service (or, in some cases a set of services) with characteristics determined to be indicative of the presence of a condition or procedure. Characteristics that define a trigger event include the diagnosis and/or procedure codes on the claim(s), and other attributes of the service(s) such as place or type of service, or provider type. When more than one service is required, their relationship in time may be considered.

### III. Episode Bounds

Rules are established to determine the epispodes bounds (the time between the start and end date of a defined episode). The start date for an episode is the first date of its trigger event, less the number of days in the look-back period if applicable. The end date of an episode is the trigger event end date plus the number of days in the look-forward period. Different conditions may have different default look back periods, such as for example, chronic condition episodes by default have a 30-day look back period and remain open until the end of the study period. Default look-back periods and episode lengths for each episode are given in the ECR metadata.

The basic calculations for episode time windows are subject to the various modifications such as death of the patient (which closes open episodes); procedural truncation (because of overlap of first and second procedural episodes); and episode extension such as with an inpatient stay assigned toward the end of the episode window.

### IV. Levels of Association

An association indicates a relationship between two episodes. In an association, two episodes coexist, with one being subsidiary to the other provided that their time windows overlap. The subsidiary episode and the services assigned to it may be viewed (analyzed) on its own, but they may also be viewed, at another level, as assigned to the primary episode. At the upper level, the episodes are, in effect, consolidated and associations may occur in chains e.g., PCI (Percutaneous coronary intervention)—AMI (acute myocardial infarction) and AMI—CAD (coronary artery disease). There are several types of associated episodes, including:
Certain procedural episodes that are subsidiary to related acute medical episodes, e.g., PCI is subsidiary to AMI.
Certain acute medical and procedural episodes that are subsidiary to related Chronic or Other Condition episodes, e.g. AMI and PCI are subsidiary to CAD.
Procedural or acute medical episodes that trigger while an episode of the same type is open, which are subsidiary to the already open episode, and usually categorized as a complication.

Associated episodes can be flagged as either typical or complication. Associations and their classification are specified in the ECR metadata. Please note that within ECR Analytics, leveling occurs after service assignment, which is described in more detail below.

There are 5 Levels of clinical associations of episodes for any health plan beneficiary who has had more than one episode triggered. At each Level, the sum of all ECRs plus the unassigned costs equal the total costs of care for the patient for a defined period of time. In addition there are various rules applied with creating episode association levels.

Level 1: All episodes are triggered at Level 1 and all service assignments occur at Level 1. SRFs are also triggered and assembled at Level 1. Services are preferably assigned to an ECR, but if not picked up by an ECR, they would find a home in an Unassigned bucket. An ECR is only associated to another ECR at a higher level.

Level 2: Used to merge typical associations within an episode family (e.g. cardiac, GI, delivery) and category (procedural or acute only). For example, Colonoscopy following a Colon Resection—both are in the same episode family clinically (i.e. GI) and the same episode category or type of episode (i.e. procedural).

Level 3: Used to complete Procedural ECRs. All complication associations to procedural episodes (i.e. procedural ECR is primary) as well as any remaining typical associations to procedural episodes not completed at Level 2 are associated at Level 3.

Level 4: Used to complete Acute ECRs. All complication associations to acute episodes (i.e. acute ECR is primary) as well as any remaining typical associations to acute episodes not completed at Level 2 are associated at Level 4.

Level 5: Used to complete Chronic and Other Condition ECRs. All complication and typical associations to chronic/other condition episodes are associated at Level 5.

Note that ECR budgets are created at each Level separately because they are not equal to the simple sum of lower Level ECR budgets (since costs of ECRs can be split as they move up Levels).

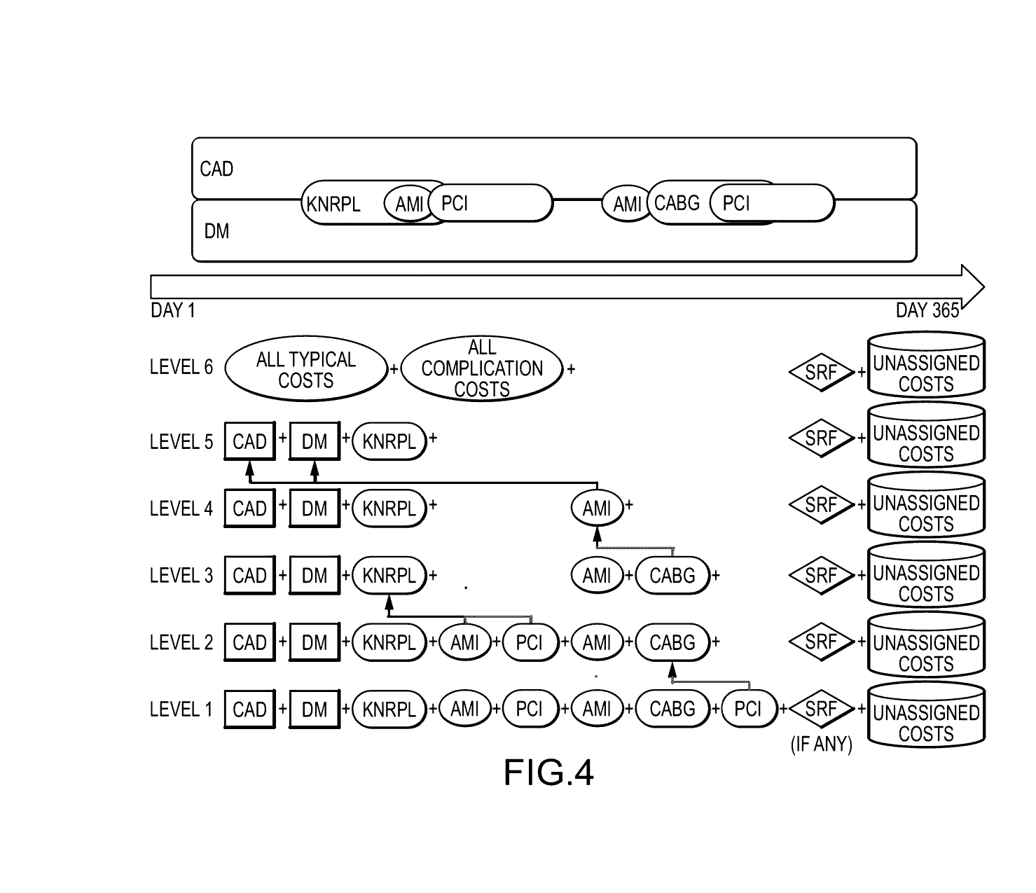

FIG. 4 provides an example of the episodes a patient experienced over the course of one year and how those episodes are associated to one another at different levels. The patient has both Coronary Artery Disease (CAD) and Diabetes (DM). In the first half of the year, the patient underwent Knee Replacement surgery. Within 90 days of the Knee procedure, the patient had an Acute Myocardial Infarction (AMI) and a Coronary Angioplasty (PCI) to treat the AMI. Several months later, in the second half of the year, the patient had another AMI followed immediately by a Coronary Artery Bypass Graft (CABG) followed by a PCI. The figure below represents the relationship between the episodes over time as well as across levels of association.

All episodes exist at Level 1 and all service assignments are made. At Level 2, PCI is associated as Typical to CABG (indicated by the blue arrows in the figure). At Level 3, the PCI is associated as a Typical treatment for the first AMI. Also at Level 3, the first AMI (with its associated PCI) is associated as a Complication to KNRPL (indicated by the red arrows in the figure). All procedural episodes are complete at Level 3. At Level 4, the CABG is associated as a Typical treatment for the second AMI—all acute episodes are complete at Level 4. At Level 5, the second AMI is associated as a Complication to the underlying chronic conditions of CAD and DM. Please note that at this point in time, V5.0 does not include any chronic episodes to which Knee procedures can be associated and so KNRPL continues to exist at Level 5. All chronic episodes are complete at Level 5. System Related Failure (SRF) episodes and Unassigned Costs are accounted for at each Level. Please note that there are no SRF episodes in this example. Level 6 represents the total cost of care for the year for this patient. Costs for the episodes are split between Typical and Complication as they were assigned at Level 5. Complication costs also include the cost of System Related Failure episodes. The sum of the patient's Typical, Complication, and Unassigned costs equal the total cost of care for the year. The sum of the episode costs, SRFs, and unassigned costs are equal at each Level.

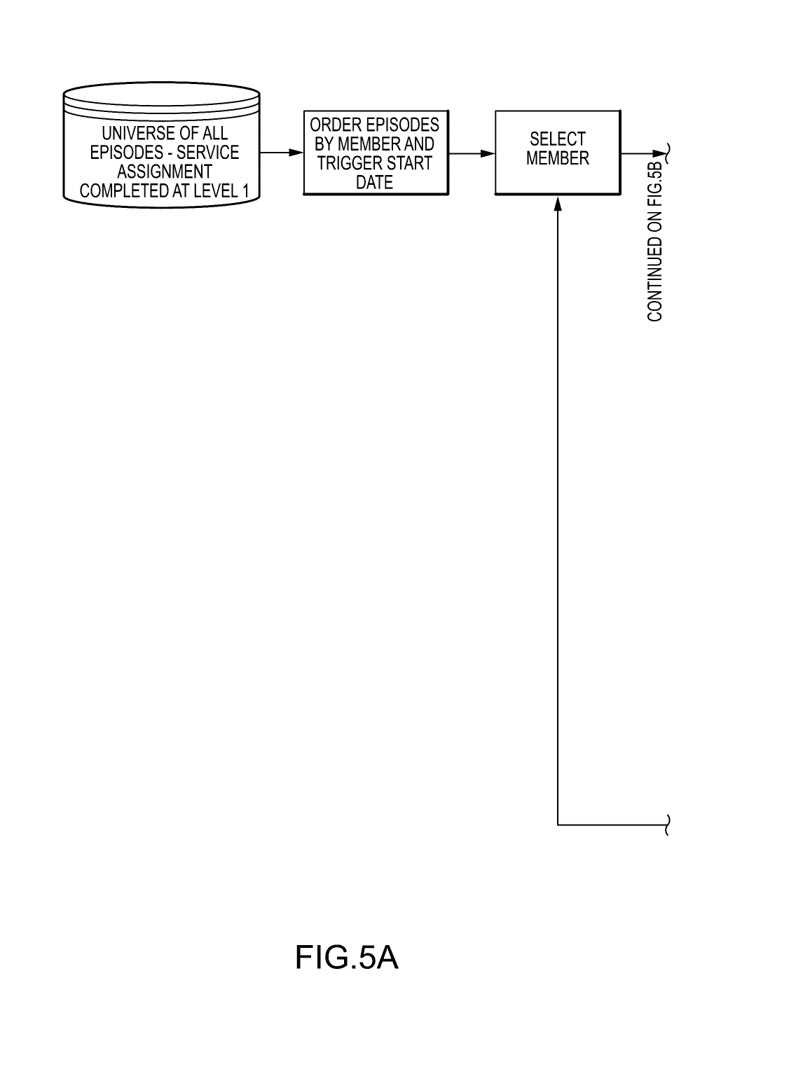

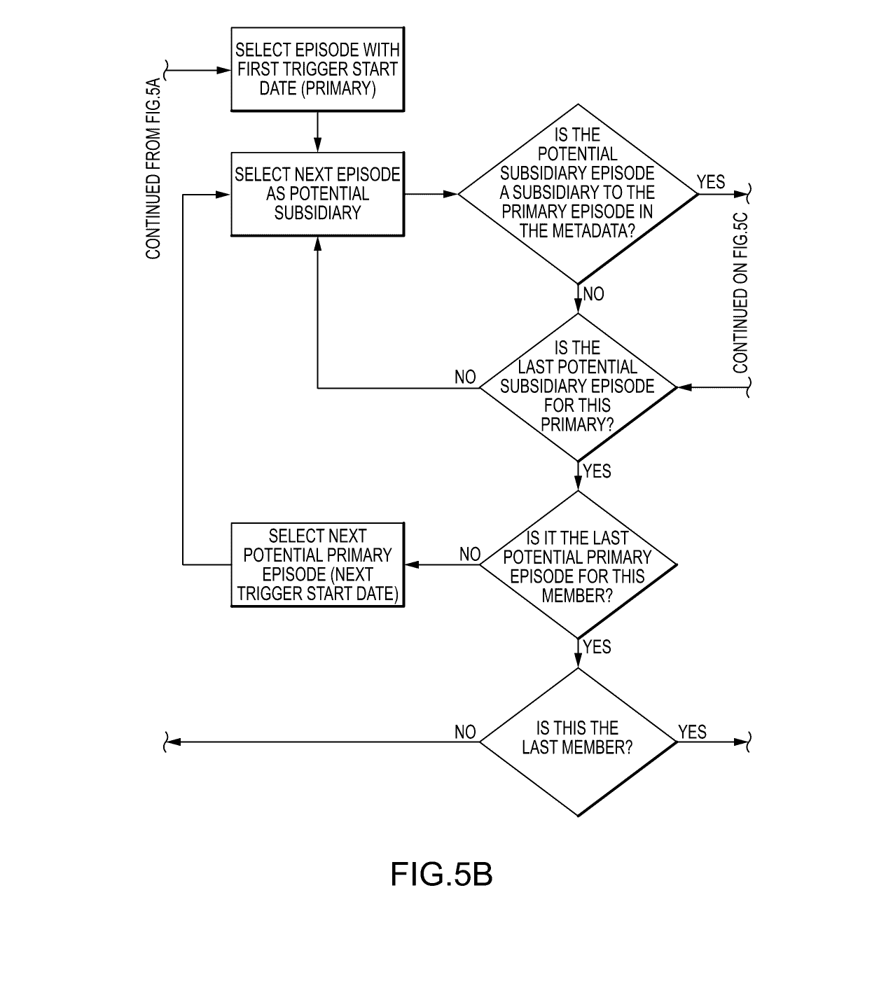

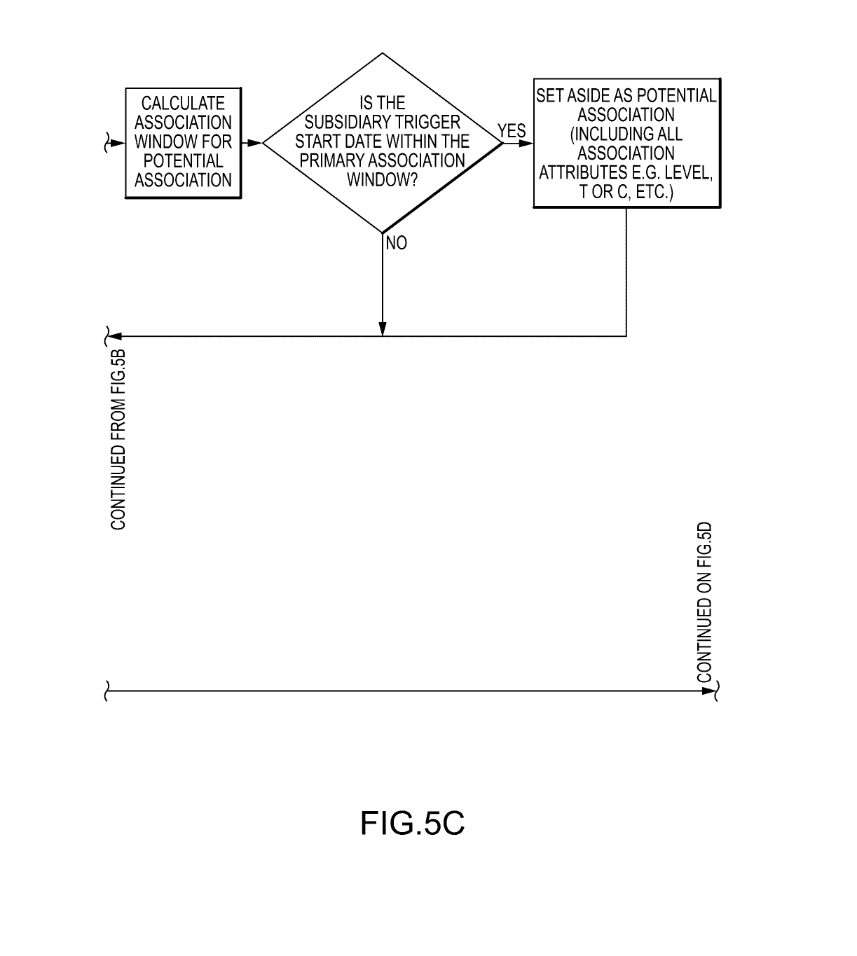

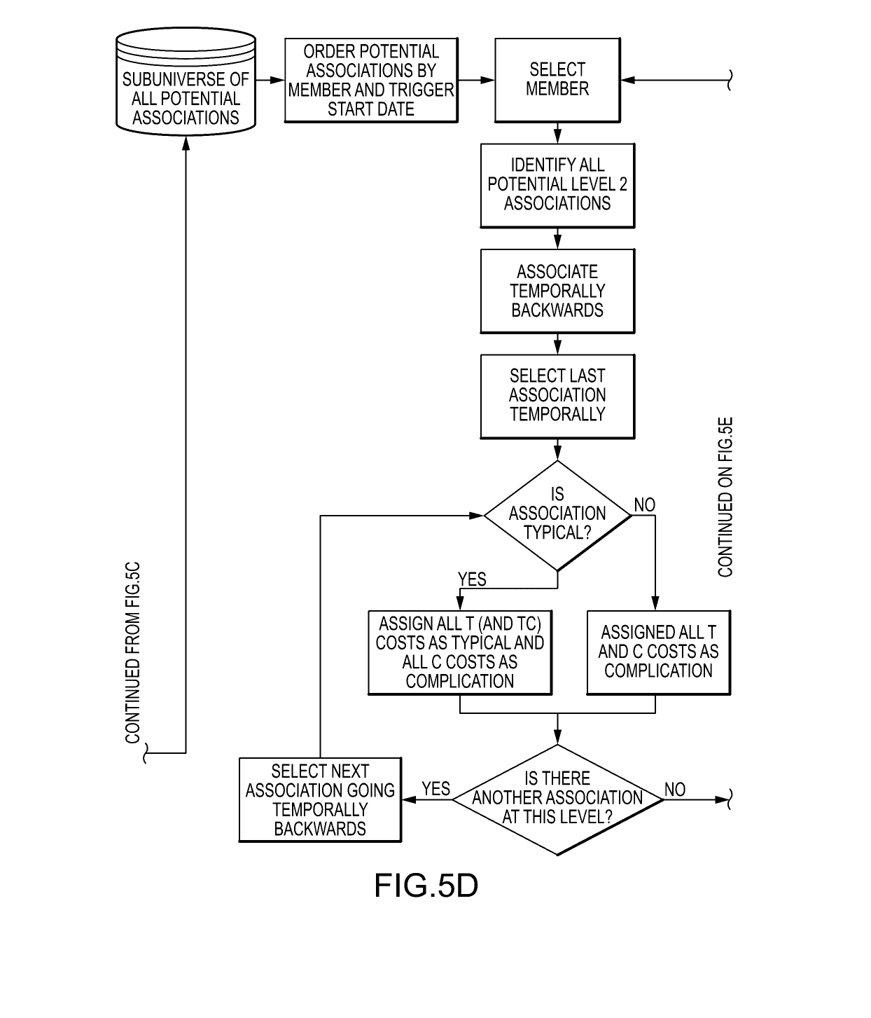

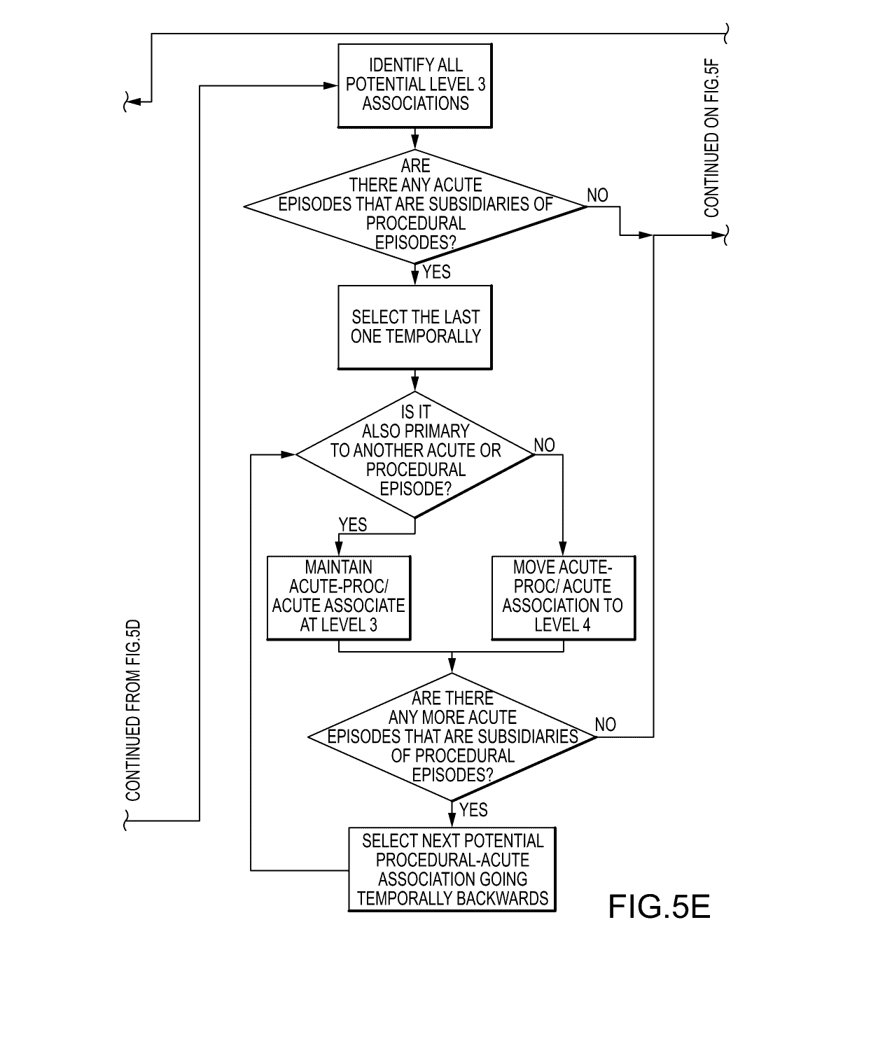

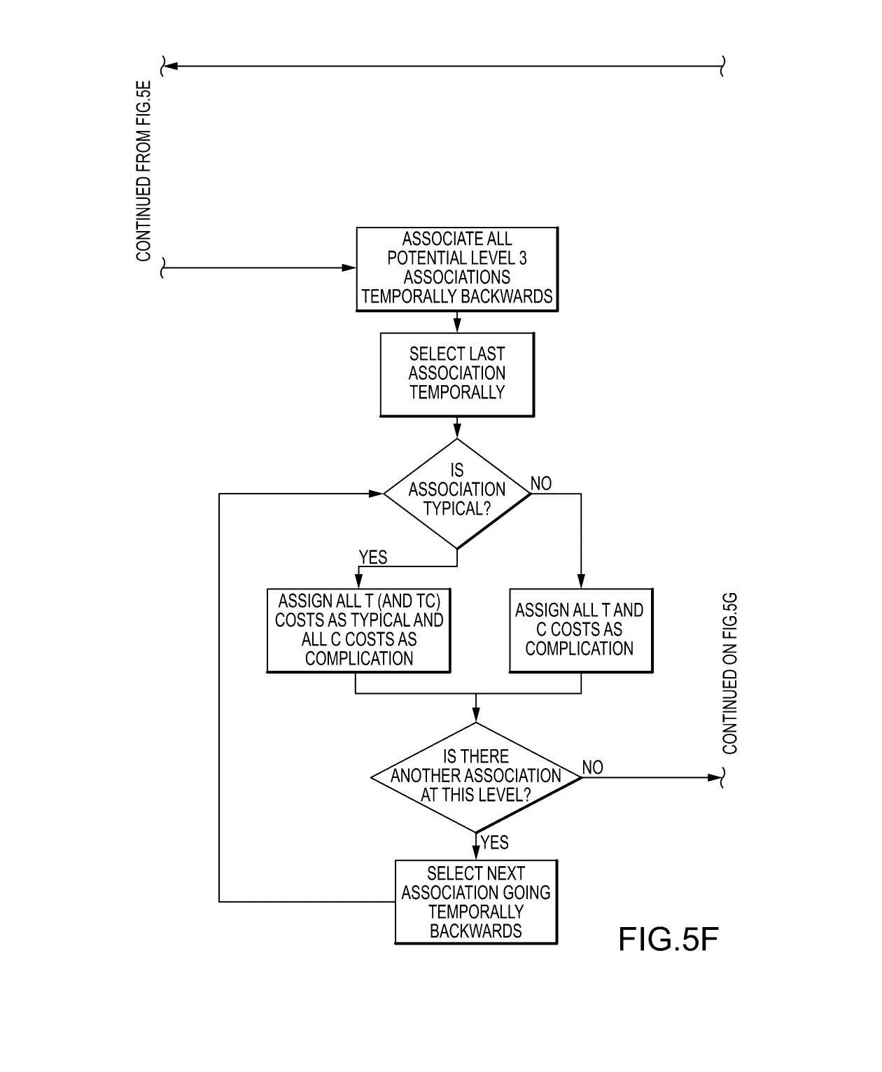

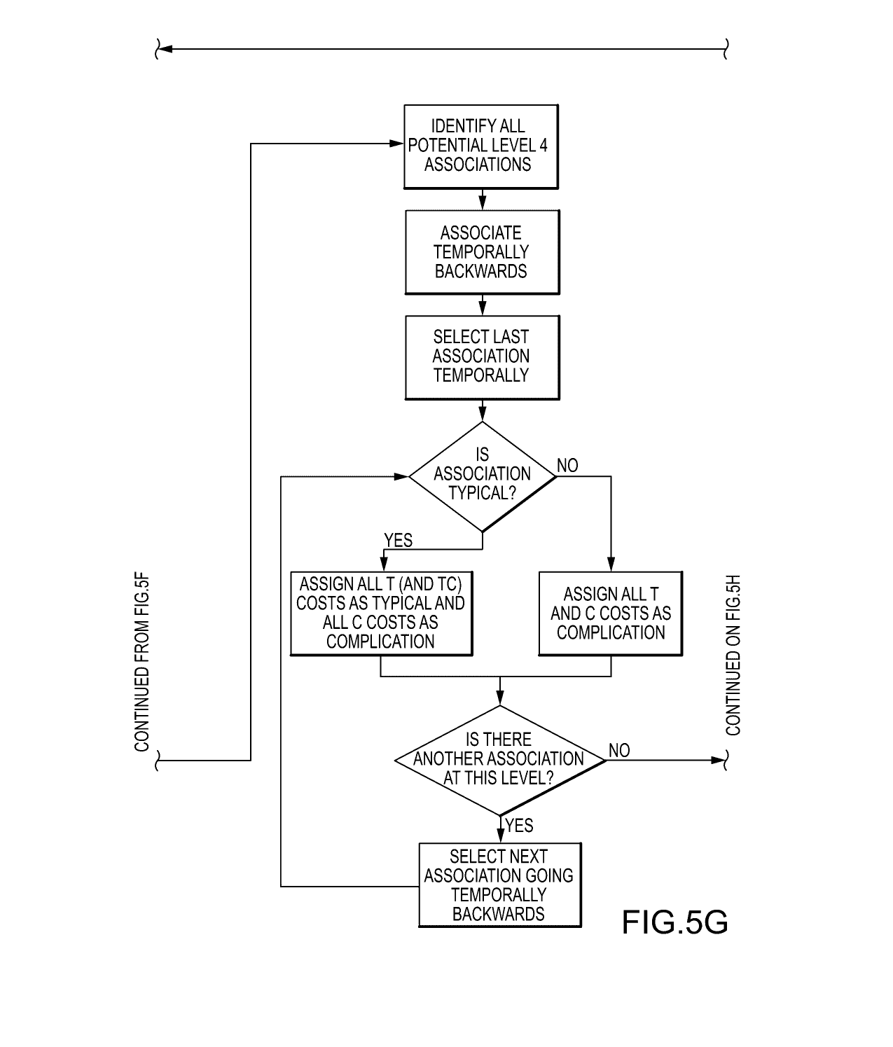

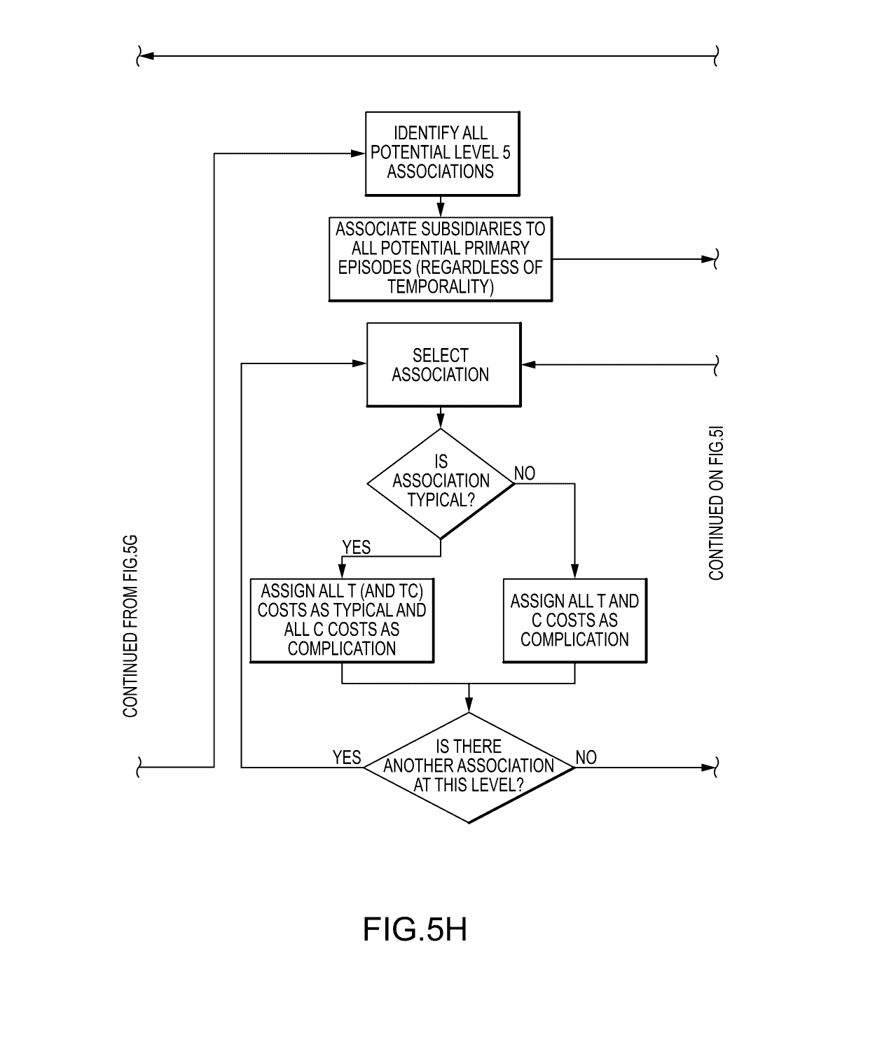

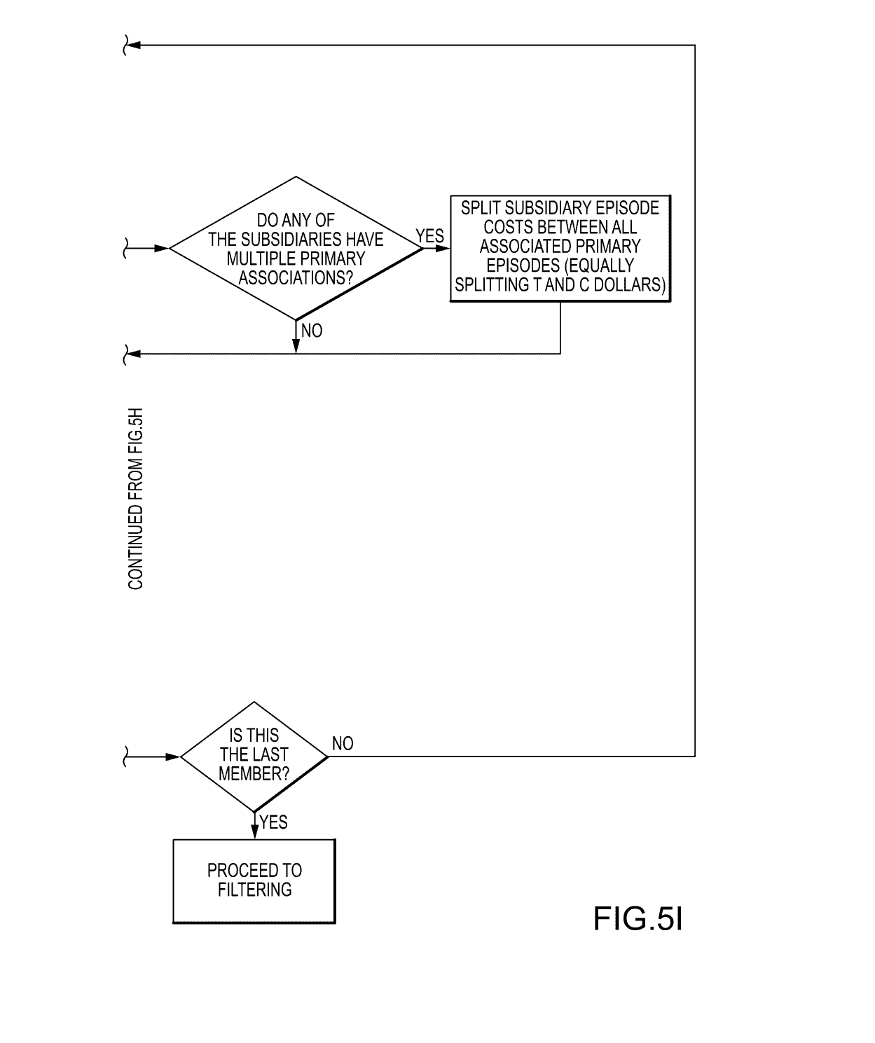

Referring to FIGS. 5A-5I, in accordance with an embodiment of this invention, the following rules should be applied when creating episode association levels: all episodes should be rolled up starting at Level 2 and ending with Level 5 based on the Association rules.
1) All dollars from the subsidiary episode should be rolled into the primary episode at each level.
2) When an episode is associated to another episode as typical, all of the downstream costs that get included in the episode remain classified as typical or complication as previously assigned.
3) When an episode is associated to another episode as complication, all of the downstream costs that get included in the episode are classified as complication for the primary episode.
4) If there are multiple valid associations for an episode at Levels 2, 3 and 4, then the episode should be associated temporally, beginning with the episode with the latest end date and working sequentially backwards.
5) If there are multiple valid associations for an episode at Level 5, then the temporal association no longer applies and acute/procedural ECRs should be evenly split between any associated chronic and other condition ECRs since they are much longer and/or ongoing.
6) Any episode not associated/rolled into another episode at a given level, should be maintained at that level to ensure that total costs at each level are always equal.
7) When an acute episode is subsidiary to a procedural episode, but also primary to a subsequent procedural episode, the subsequent subsidiary procedural episode (the last episode in the chain) is associated to the acute episode at Level 3. Then, the acute episode is also associated to the primary procedural episode at Level 3.

Additionally, when an acute episode is subsidiary to a procedural episode, but also primary to another acute episode, the last acute episode is associated to the first acute episode at Level 3. Then, the first acute episode is also associated to the primary procedural episode at Level 3.
8) Association start date is calculated based on the primary episode's trigger start date. If the association start date is set to default in the ECR metadata, then the association start date is equal to the primary episode trigger start date. If there is a value populated, then that number of days is subtracted from/added to the primary episode trigger start date to determine the association start date.
9) Association end date is calculated based on the primary episode's trigger end date. If the association end date is set to default in the ECR metadata, then the association end date is equal to the primary episode's episode end date. If there is a value populated, then that number of days is subtracted from/added to the primary episode trigger end date to determine the association end date.

The association rules are provided via the ECR metadata.

### V. Service Assignment

Episode identification is done at the patient level, considering only services that meet the criteria for a trigger event. In contrast, service assignment applies to each individual unit of service. The logic for service assignment acts on the unit of service, but is still patient centered in that it takes into account all episodes for the patient that are open on the date-of-service and, where indicated, other services that are proximate in time.

Service assignment occurs at Level 1 only and consists of (1) comparing the diagnosis and procedure codes for the service with the episode definition tables/Metadata and the list of episodes open at the time of the service to determine which open episode(s) a service is relevant to, and (2) for each such assignment, determining whether the service is typical for the episode, or a complication, or in some cases typical but with complication.

A service may be assigned to an episode either if it has relevant diagnosis and/or procedure codes, or if it is proximate in time to a major service that is assigned to the episode. Services can be assigned to more than one episode, and a service can be assigned as typical for one episode and complication for another.

Each assignment of a service to an episode is classified as either typical, complication or typical with complication. The primary method for making this classification is through the ECR Metadata. However, relationship in time is also a factor and applies to two claim types: (1) Inpatient (IP) facility, and (2) all other services.

There are two service assignment options that can be turned on or off at the user's discretion in the user defined parameters: The Inpatient Bubble and the Typical Lookback Toggle.

With the “Inpatient Bubble,” users have the option to create a bubble around the inpatient stay for all episodes. The bubble assigns associated professional services (from admission through discharge) in the same manner as the IP stay is assigned (Typical, or Typical with Complication). If the Inpatient Bubble is turned off however, then associated professional services are assigned according to the standard service assignment rules for all other services based on the diagnosis and procedure codes on the services as defined by the ECR metadata.

With the “Typical Lookback Toggle” users have the option to assign all services that occur during an episode's lookback period (i.e., prior to the trigger event) as Typical. If the Typical Lookback is turned off however, then all services that occur during an episode's lookback period are assigned based on the diagnosis and procedure codes on the services as defined by the ECR metadata.

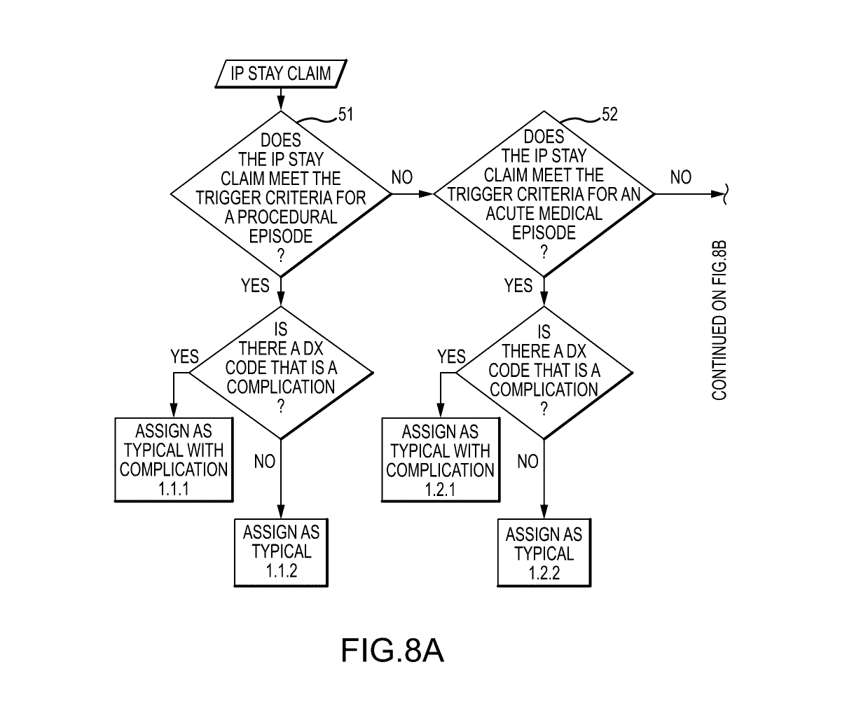

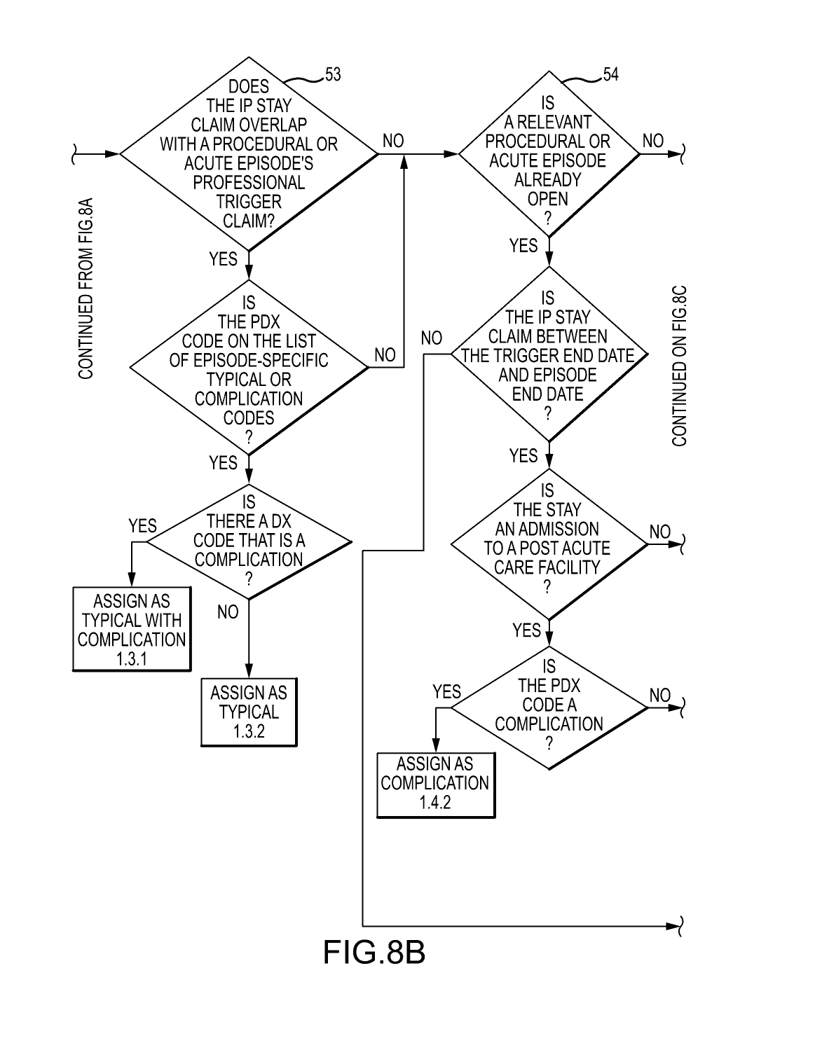

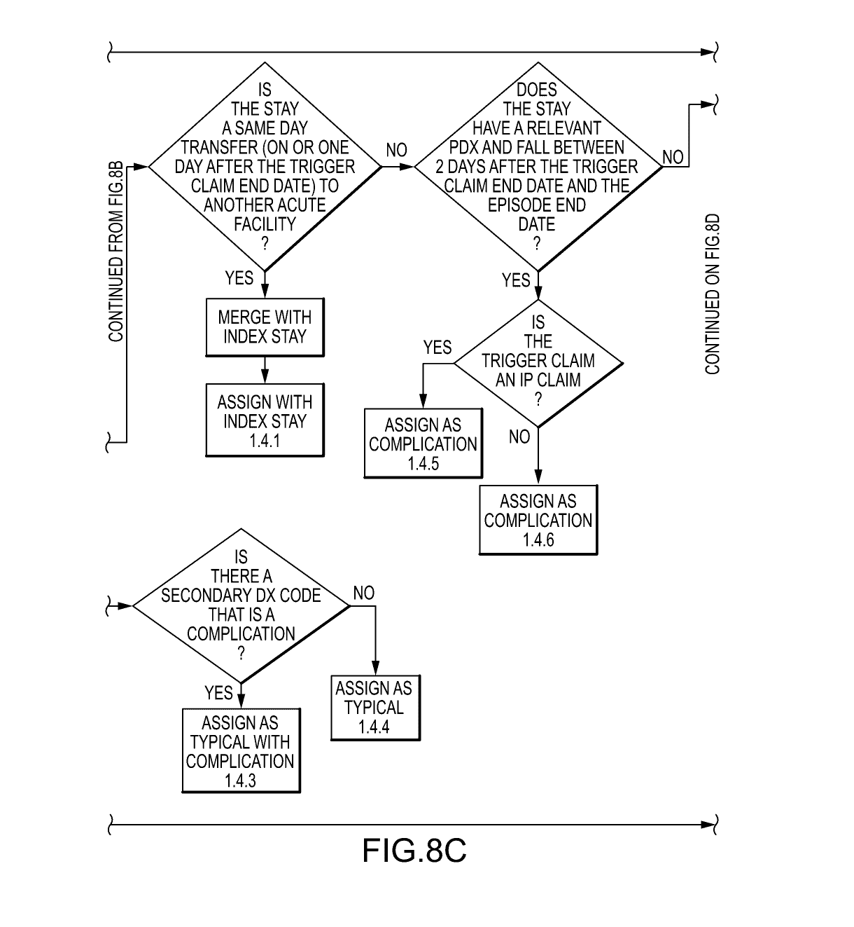

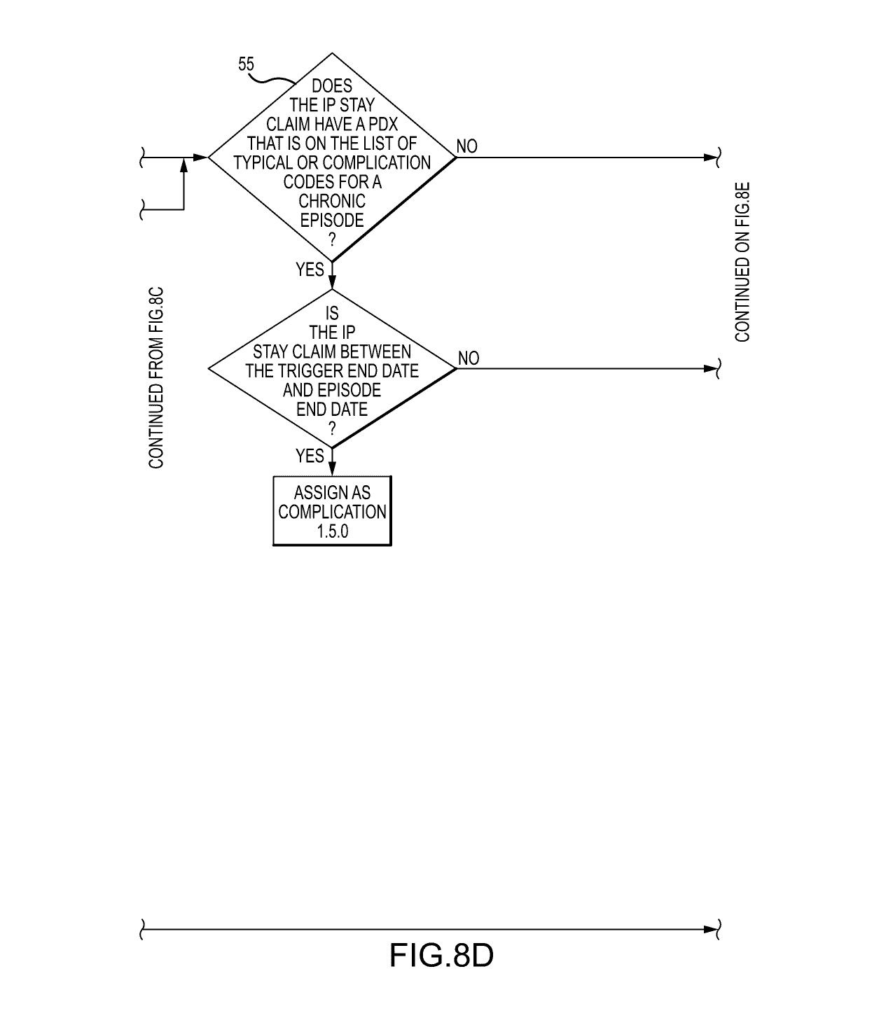

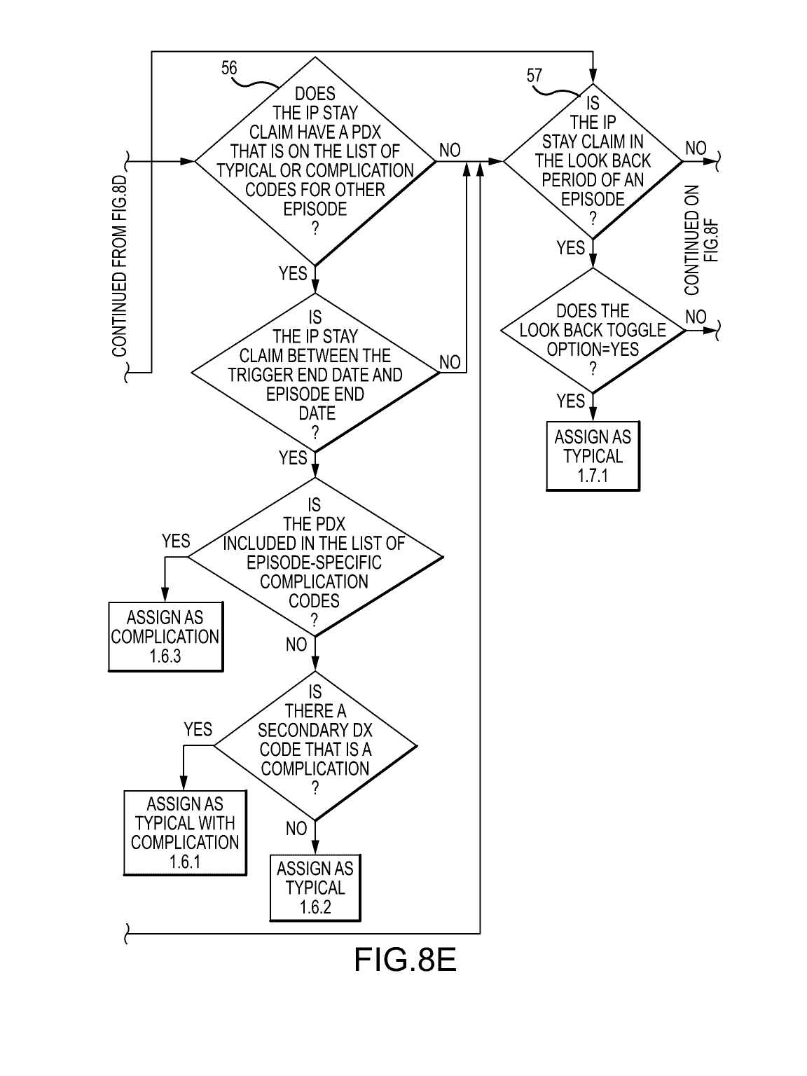

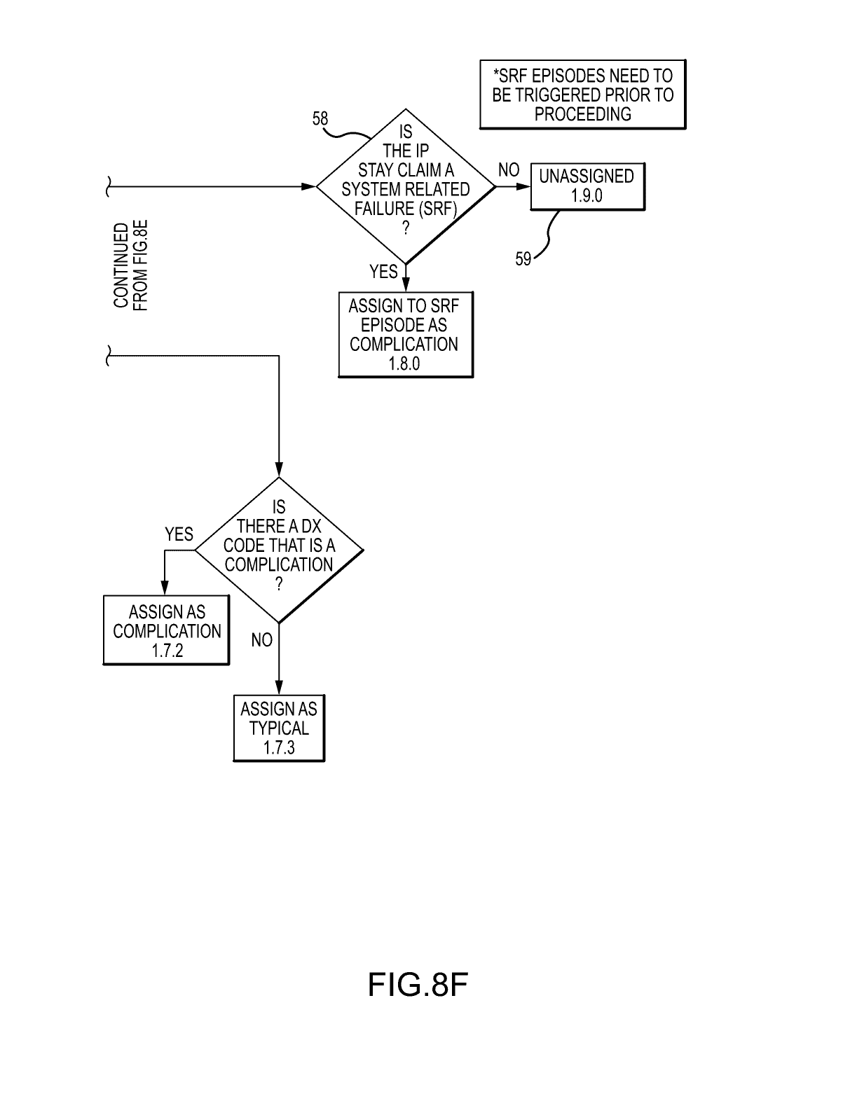

FIGS. 8A-8F provide a flow chart illustrating the process of assigning inpatient (IP) facility services, to episodes in accordance with an embodiment of the present invention where the unit of assignment of inpatient hospital services is the stay, i.e., the entire hospital stay is assigned as a unit. In the case of transfers from one acute (short-term) hospital to another, the transferring stay is considered part of the receiving stay for purposes of assignment.

### IP Facility Services

Referring still to FIGS. 8A-8F, there are 11 general rules for assignment of IP facility services, applied in sequence. Each rule is terminal; meaning that if an episode assignment is made at that step no further assignment is made. The 11 rules are described below:
1. Stays with a procedural episode trigger 51. If the stay has a procedure (and a qualifying diagnosis) that is on the trigger list for a procedural episode, it triggers the episode and is assigned to that episode as a typical service. However, if it has a diagnosis that is listed as a complication for the assigned episode, it is categorized as typical with complication. If a procedural episode is triggered during the same stay as an acute medical episode, the stay gets assigned to both episodes, but all the dollars get allocated solely to the procedural episode. The professional services in the inpatient bubble get singly assigned to the procedural episode.
2. Stays with an acute medical episode trigger 52. If the stay has a principal diagnosis that is on the trigger list for an acute medical episode then it is assigned to that episode, and categorized as typical, unless it has a diagnosis that is listed as a complication for the assigned episode, in which case it is categorized as typical, with complication.
3. Stays for procedural or acute episodes with trigger overlap 53. If the stay does not contain a trigger code for a procedural or acute episode, but contains a principal diagnosis code that is relevant to the episode and overlaps with the episode's Professional trigger claims, then the stay should be assigned to the episode and categorized as typical. If the stay has a diagnosis that is listed as a complication for the assigned episode, it is categorized as typical, with complication.
4. Subsequent IP Stays 54. Subsequent IP stays are IP stays following a procedural or acute episode trigger (whether IP, OP or Professional). These include same day transfers, which are assigned based on the initial IP stay's assignment; post-acute IP stays which are assigned as typical if they contain no complication codes for the assigned episode, complication if the principal diagnosis code is listed as a complication, and typical with complication if a secondary diagnosis code is listed as a complication; and readmissions, which are repeat admissions to an acute care facility that occurs within 2 days after the trigger claim end date and the episode end date and are assigned as complication.
5. Chronic Episode Admissions 55. An IP stay that has a principal diagnosis code on the list of typical or complication codes for a chronic episode is classified as a complication.
6. Other Episode Admissions 56. An IP stay that has a principal diagnosis code on the list of typical codes for an “other condition” episode and contains at least one diagnosis that is a complication for that episode is classified as typical, with complication. If the IP claim contains no complication codes, it is categorized as typical. If the principal diagnosis code is a complication, it is categorized as complication.
7. Stays in the look back period 57. There are two options for assigning stays in the look back period of an episode: (1) either all relevant IP claims are assigned as typical; or (2) IP claims are assigned as typical or complication based on the diagnosis codes on the claims.
8. Newborn Admissions. An IP stay that has a principal diagnosis code on the list of typical codes for a Newborn episode and contains at least one diagnosis that is a complication for that episode is classified as typical, with complication. If the IP claim contains no complication codes, it is categorized as typical. If the principal diagnosis code is a complication, it is categorized as complication.
9. System failure events 58. A stay with a principal diagnosis code that is on the list of system related failure trigger codes but is not relevant to any open episode is categorized as a system-failure event, and cannot be assigned to any other episode.
10. Sick Care Admissions. A stay with a principal diagnosis code that is on the list of relevant codes for a Sick Care episode and cannot be assigned to any other open episode is categorized as a complication.
11. Unassigned services 59. Services not assigned by any of the preceding services are classified as unassigned.

### All Other Services

The unit of assignment of outpatient and professional services is at the service or claim line level. Unless noted, position of diagnosis and procedure codes on the claim is not considered.

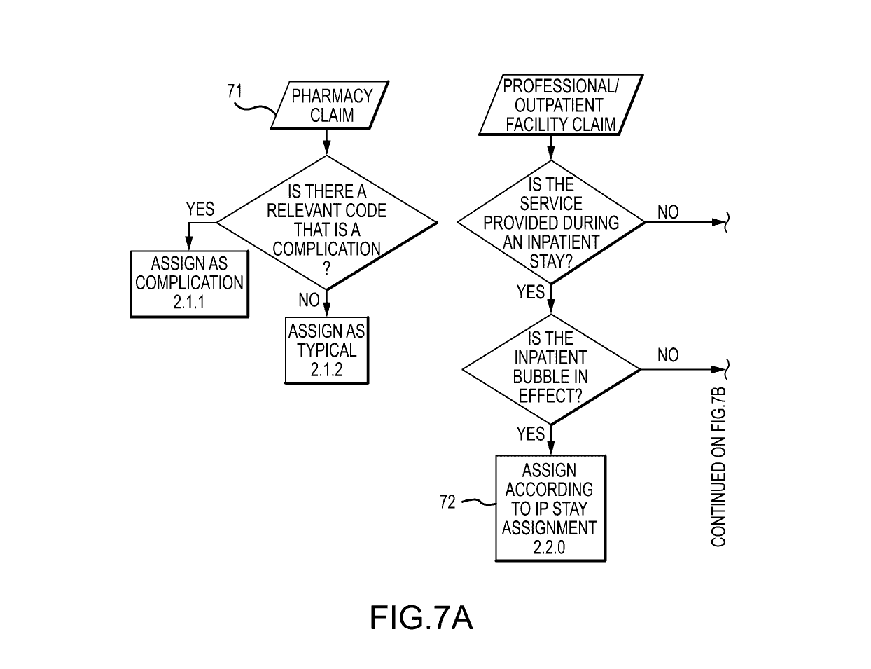

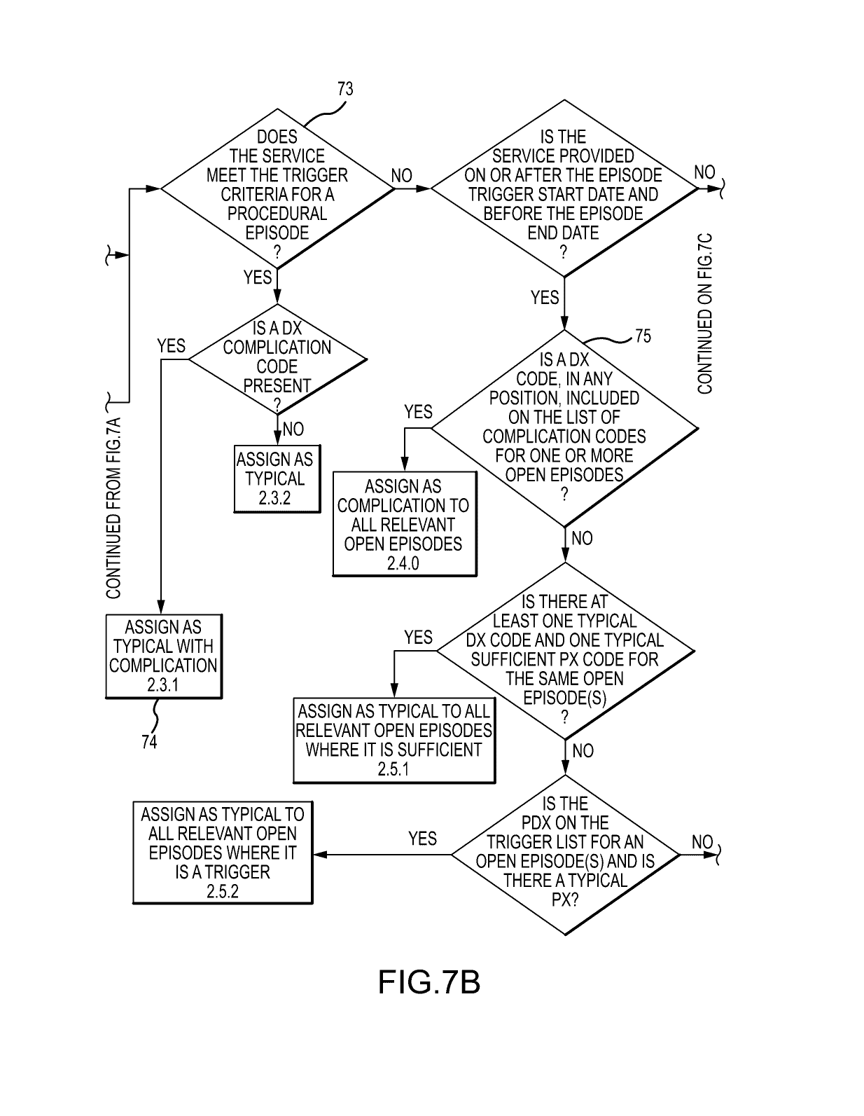

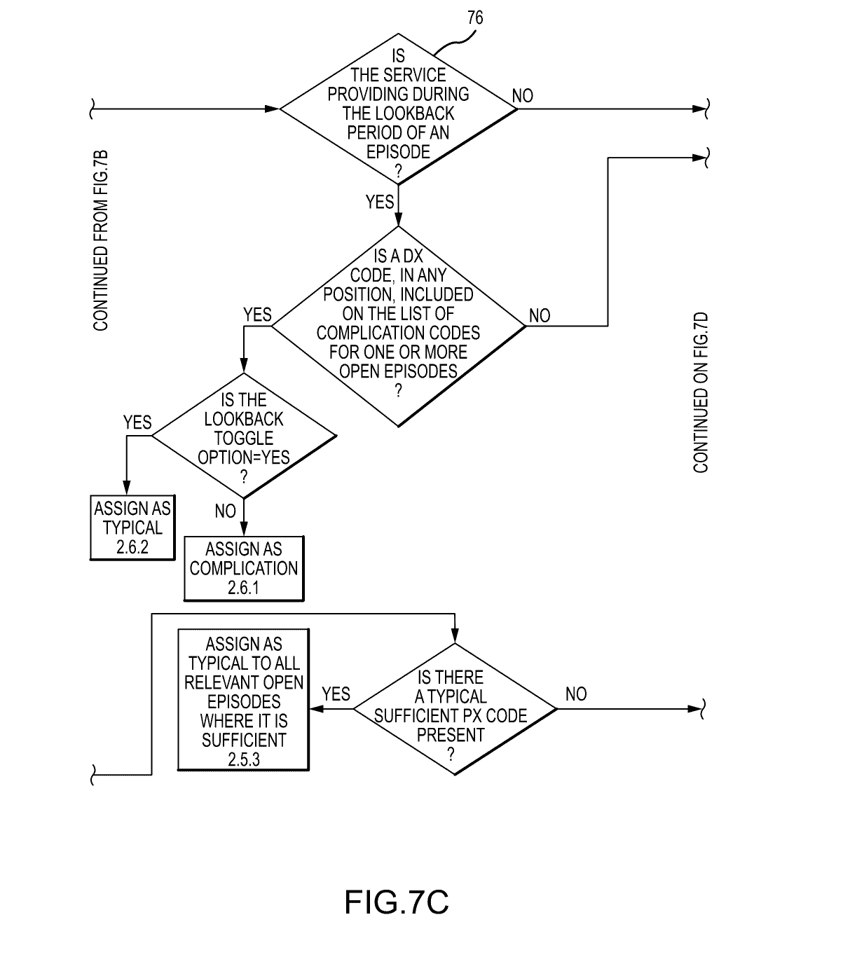

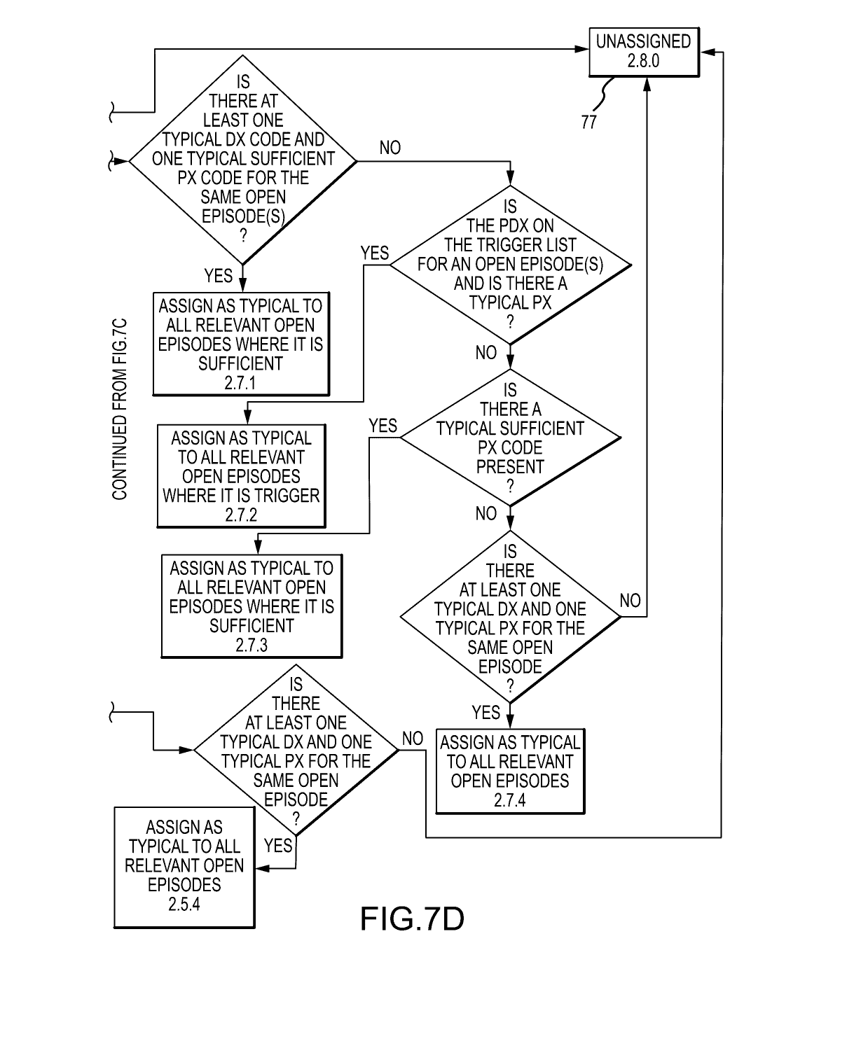

There are thirteen rules for assignment of all other services, applied in sequence. FIGS. 7A-7D provide a flow chart illustrating the process of assigning services to episodes, other than the ones covered by the inpatient facility services, in accordance with an embodiment of the present invention where the unit of assignment of outpatient and professional services is at the service or claim line level, and unless noted, position of diagnosis codes on the claim is not considered.
1. Pharmacy. Pharmacy claims are assigned according to the episode definition tables. Currently, all pharmacy codes are assigned as typical.
2. Services during IP stay. If the professional service occurs during an acute IP stay it is assigned to the same episode as the IP stay is assigned, but categorized based on the presence or absence of complication codes on the service (the inpatient bubble). Optionally, professional services during the IP stay may instead be assigned using the applicable following rule(s) by turning off the inpatient bubble.
3. Services with a procedural episode trigger. If the service has a procedure that is on the trigger list for an open episode then it is assigned to that episode, as a typical service. However, if a diagnosis code exists that is a complication; the service is assigned as typical with complication.
4. Complication diagnoses. If the service has at least one diagnosis that is on the list of complications for an open episode then the service is assigned to that episode, and categorized a complication. The service will be assigned to all episodes meeting this condition.
5. Typical diagnoses and procedure(s). If the service has either (A) a diagnosis and a procedure designated as typical for an open episode, or (B) a procedure that has been designated as sufficient for an open episode without a relevant diagnosis code for that episode, and the service has not been assigned to that episode based on a complication diagnosis, then the service is assigned to that episode, and categorized as typical. However, if the service is assigned to more than one episode based on this rule, then the following order of precedence is applied.
i. Episode(s) for which the service has both a typical diagnosis and a typical procedure that is sufficient for the episode type. (A and B)
ii. Episode(s) with both a typical diagnosis and a typical procedure, and for which the principal diagnosis (line diagnosis in the case of Part B/Professional or DME services) is a trigger code. (A only and the PDx is a trigger)
iii. Episode(s) with no typical diagnosis, but a procedure code that is sufficient for the episode type. (B only)
iv. Episode(s) with both a typical diagnosis and a typical procedure, but with no procedure that is sufficient for the episode type. (A only)

Only the first of these criteria to be met by an episode for which typical diagnosis and/or procedure codes are on the claim is used; the service is assigned to any episode that meets that criterion, but not to those meeting later criteria in this sequence.
6. Complications in the look back period. There are two options for assigning services with complication code(s) in the look back period of an episode: (1) either all services are assigned as typical; or (2) services with a complication diagnosis are assigned as complication. The Typical Lookback toggle determines which option applies for each episode.
7. Typical services in the look back period. All other services in the look back period of an episode follow the rules set forth above in rule 2.5.
8. Newborn services. If the service contains at least one diagnosis that is a complication for the Newborn episode, it is assigned as complication. If the service contains no complication codes, it is assigned as typical.
9. System failure services. A service (including pharmacy) that occurs during a system related failure episode (other than Sick Care) and cannot be assigned to any other open episode, is categorized as a complication.
10. Sick Care pharmacy. Pharmacy claims are assigned according to the episode definition table for the Sick Care episode. Currently, all pharmacy codes are assigned as typical.
11. Sick Care complications. If the service has a diagnosis code that is a complication code for the Sick Care episode and cannot be assigned to any other open episode, it is categorized as a complication.
12. Typical Sick Care services. If the service has either (A) a diagnosis and a procedure designated as typical for an open Sick Care episode, or (B) a procedure that has been designated as sufficient for an open Sick Care episode without a relevant diagnosis code for that episode, and the service has not been assigned to that episode based on a complication diagnosis and cannot be assigned to any other open episode, then the service is assigned to that episode, and categorized as typical.
13. Unassigned. If none of the preceding rules result in an episode assignment the service is classified as unassigned.

### Consolidation

For each service, the assignment resulting from application of the rules described in Assigning Services to Episodes, IP Facility Services, and All Other Services is called the Level 1 assignment. Assignments made to a subsidiary condition are then mapped to the associated primary episode(s), resulting in additional levels of assignment. For example, a service assigned to a PNE episode that occurs during an AMI episode is in this step consolidated with the AMI episode, by adding the AMI episode at the Level 4 assignment for that service. Consolidation of subsidiary episodes that are procedural or medical into primary episodes that are procedural (e.g., AMI to CxCABG) produces the Level 3 assignment. Consolidation of subsidiary episodes that are procedural or medical into primary episodes that are acute medical (e.g., PCI to AMI) produces the Level 4 assignment. Consolidation of subsidiary episodes that are procedural or acute medical into primary episodes that are chronic or other conditions produces the Level 5 assignment. The consolidation process thus provides alternative perspectives on the same underlying reality. Like Level 1 assignments, consolidations are categorized as typical or complications, but based on the relationship of the subsidiary and primary conditions (and leveling rules), not the service-to-condition categorization used for Level 1.

### Apportionment

The ECR Analytics employs multiple assignments of services—that is, where relevant, a single service is assigned to more than one episode. In this scenario, the cost of the service is apportioned among the episodes, so that the total cost assigned to all of the beneficiary's episodes is the same as that patient's actual cost of services. The default apportionment is equal shares: if the service is assigned to two episodes, each episode is assigned half the cost of the service; if the service is assigned to three episodes, each episode is assigned one-third of the cost of the service, and so on. When consolidation occurs, apportionment is done in this manner for each level.

### Filtering

In accordance with an embodiment of the present invention when the construction of episode definition is completed, episodes may be filtered to allow only complete episodes and those relevant to the analyzed population to move forward. The following filters have default settings included in the ECR Metadata: Age Range, Minimum and Maximum Episode Cost, Coverage/Enrollment Gap, Episode Completion, DRGs. All filters are applied to each episode at Level 1. Additionally, the Minimum and Maximum Episode Cost filters are also applied to each episode at Levels 2 through 5. Episodes that do not meet the default or user defined criteria get flagged as not meeting the filter in question (at the level the filter is applied). Episodes flagged at Level 1 (or a higher level) carry their flags to subsequent levels. Primary episodes with associated subsidiary episodes that are flagged will also be flagged by association. By default, only episodes that meet all filter criteria (i.e. have no flags) proceed to Severity Adjustment. Users may have the option to select which if any filters they want to apply to this and other downstream modules.

### Provider Attribution

In accordance with an embodiment of the present invention once the episodes have been constructed and filtering has occurred, the episodes must be attributed to providers.

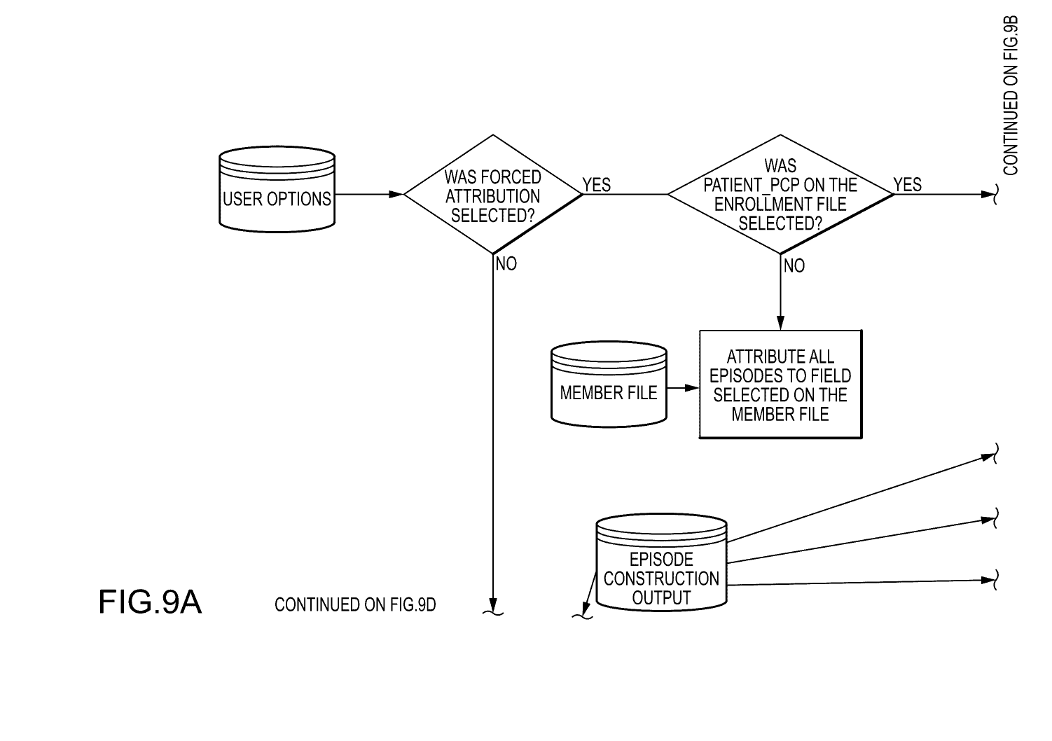

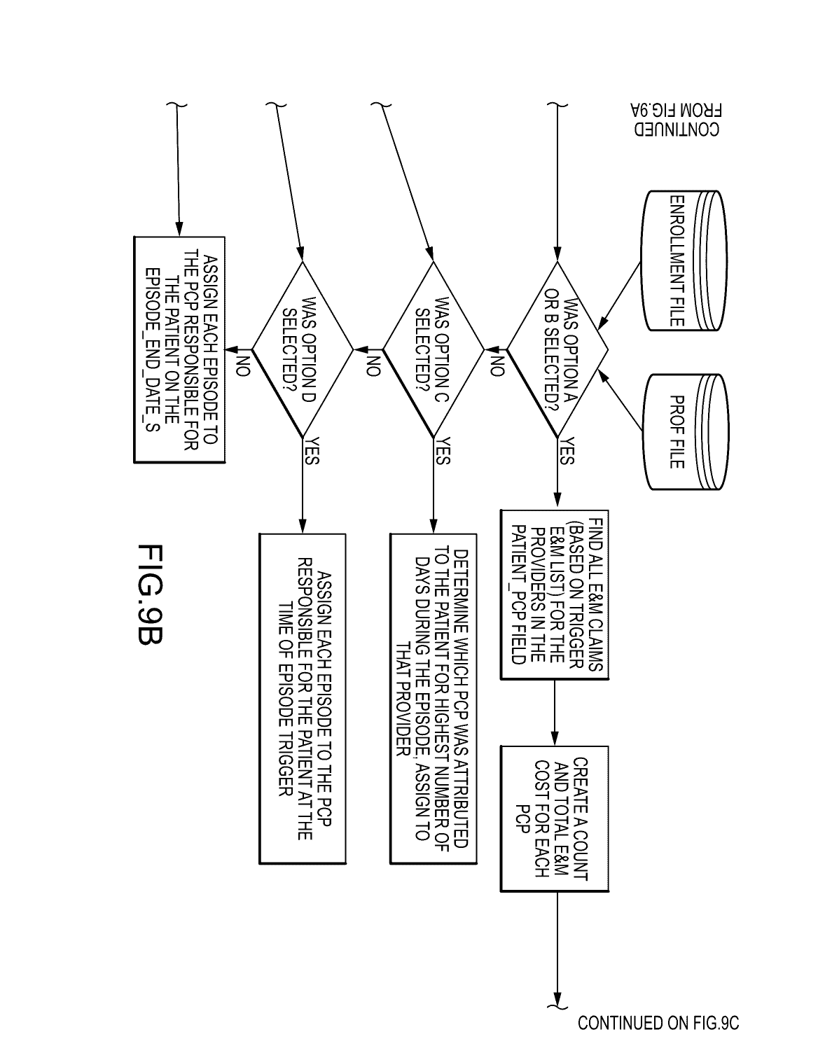

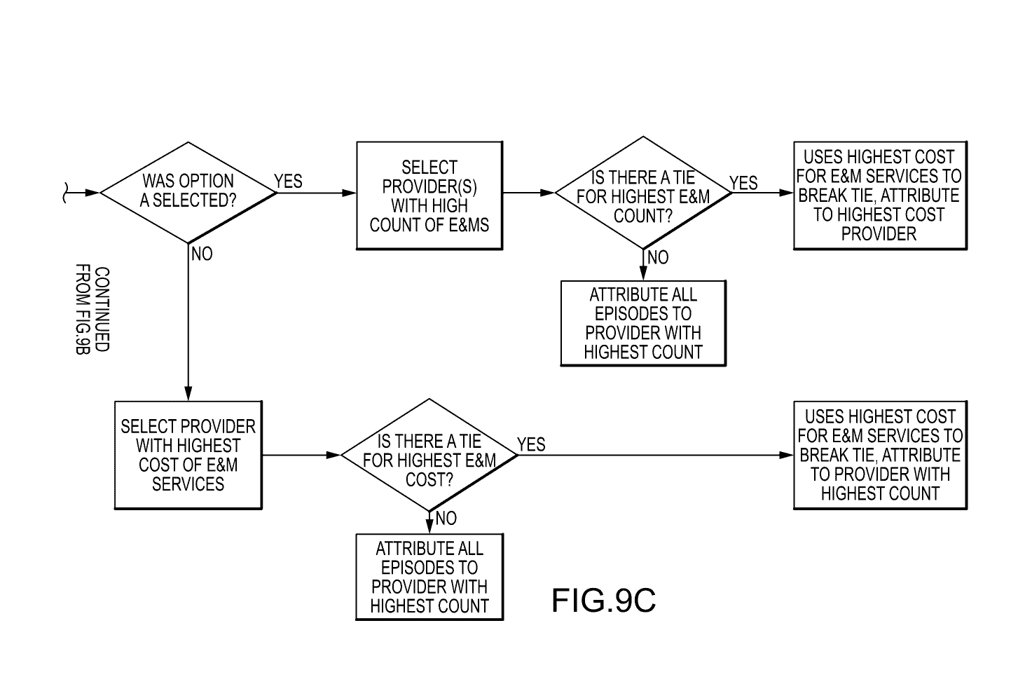

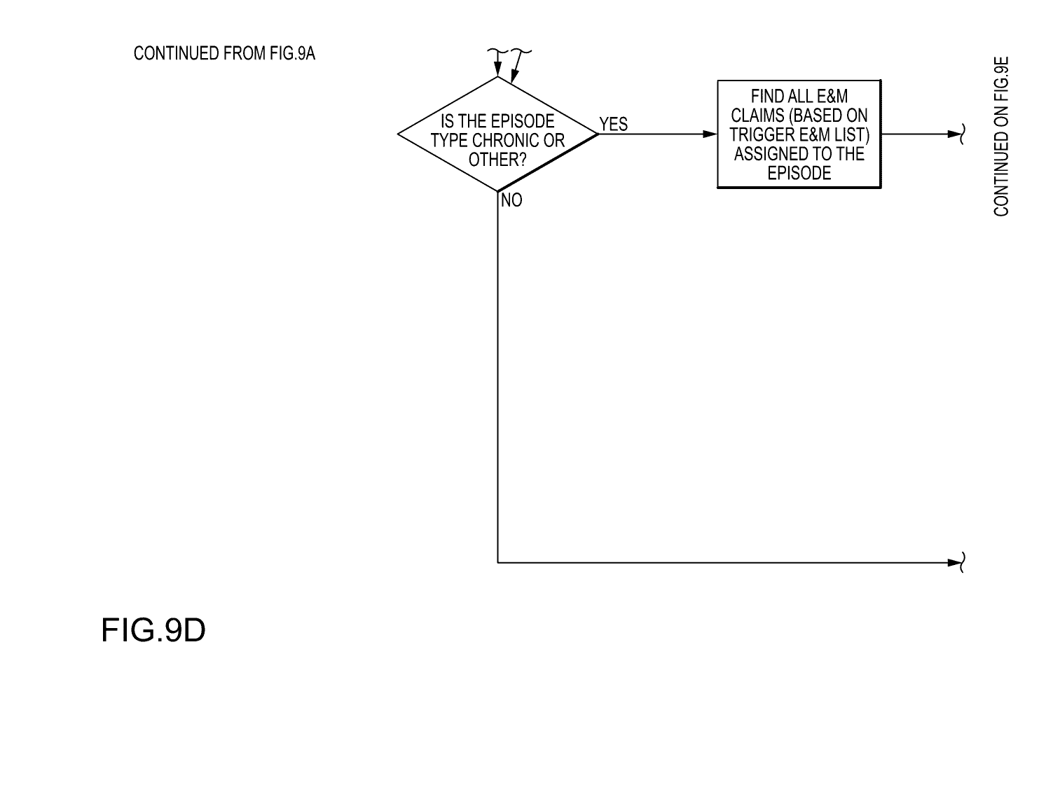

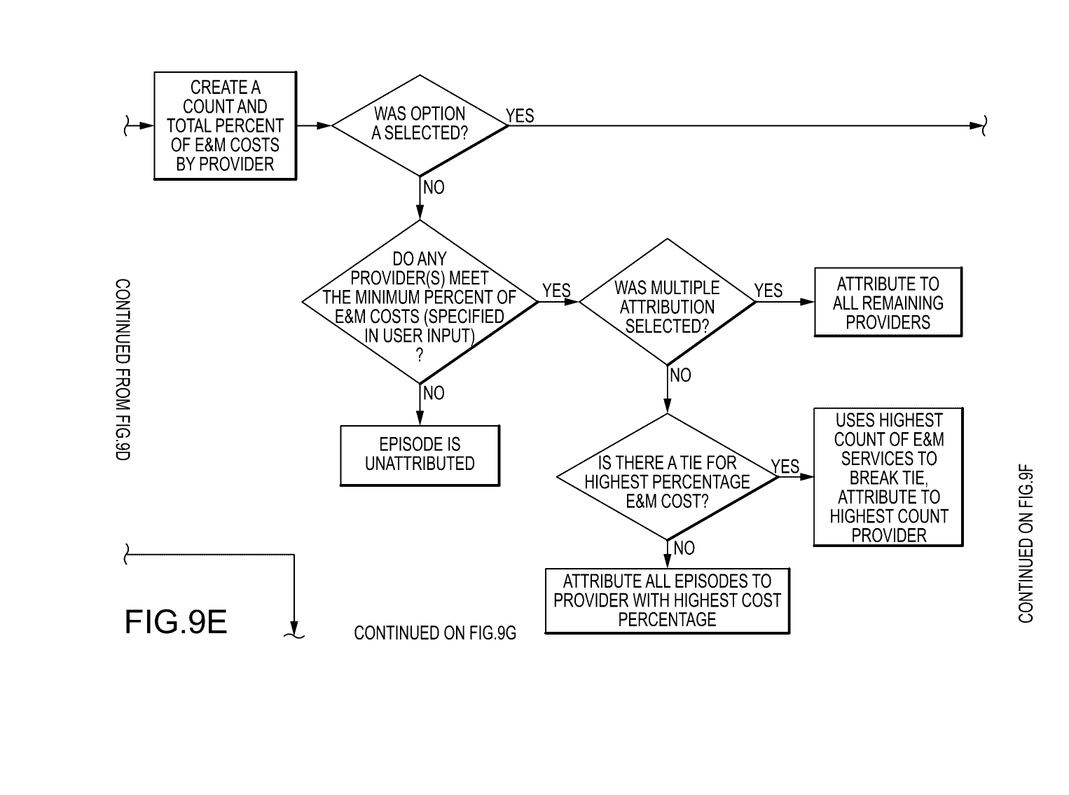

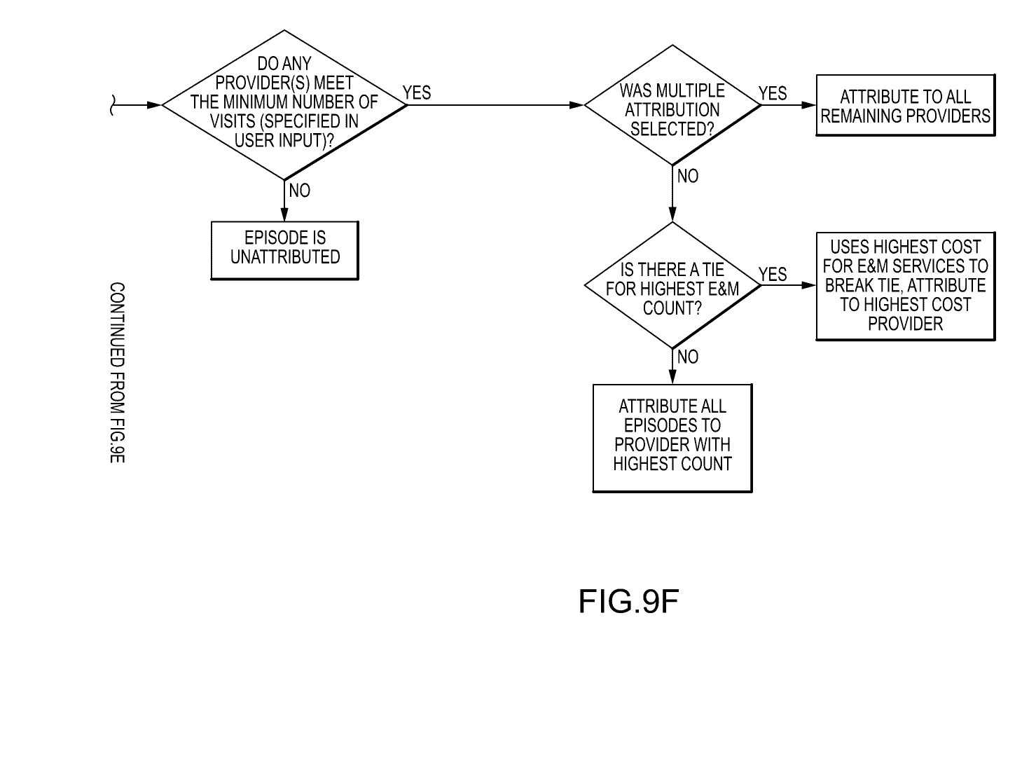

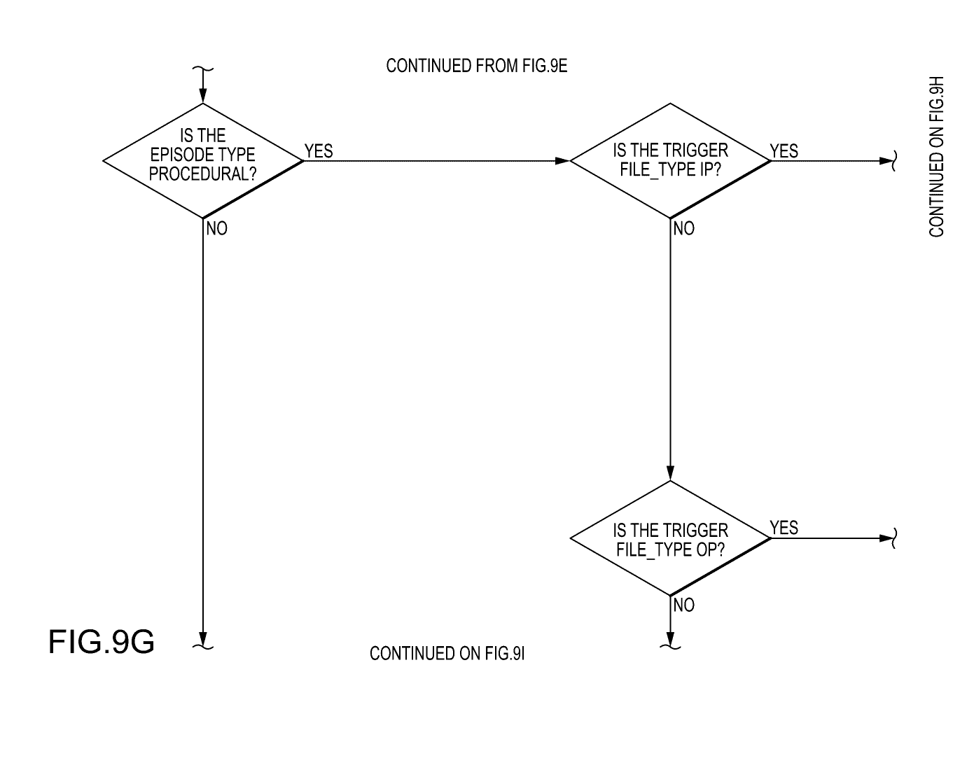

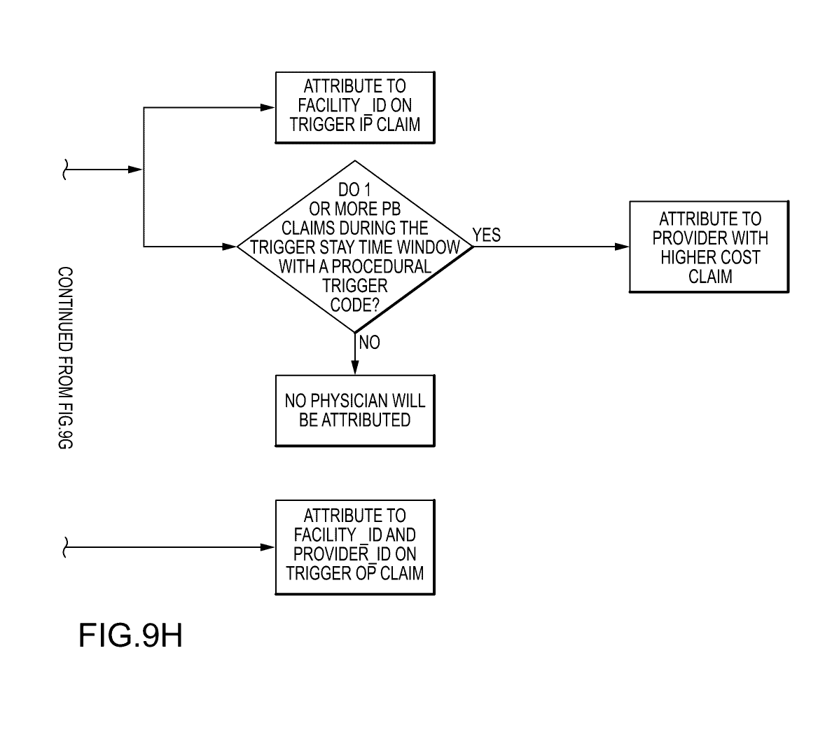

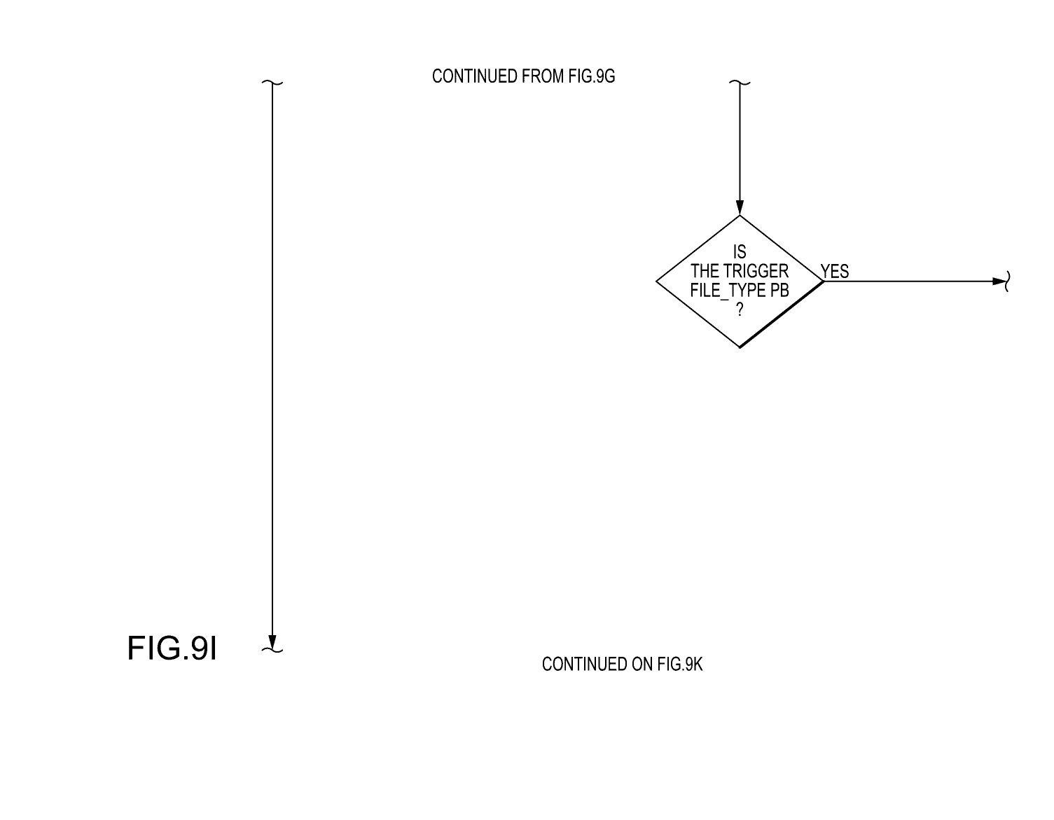

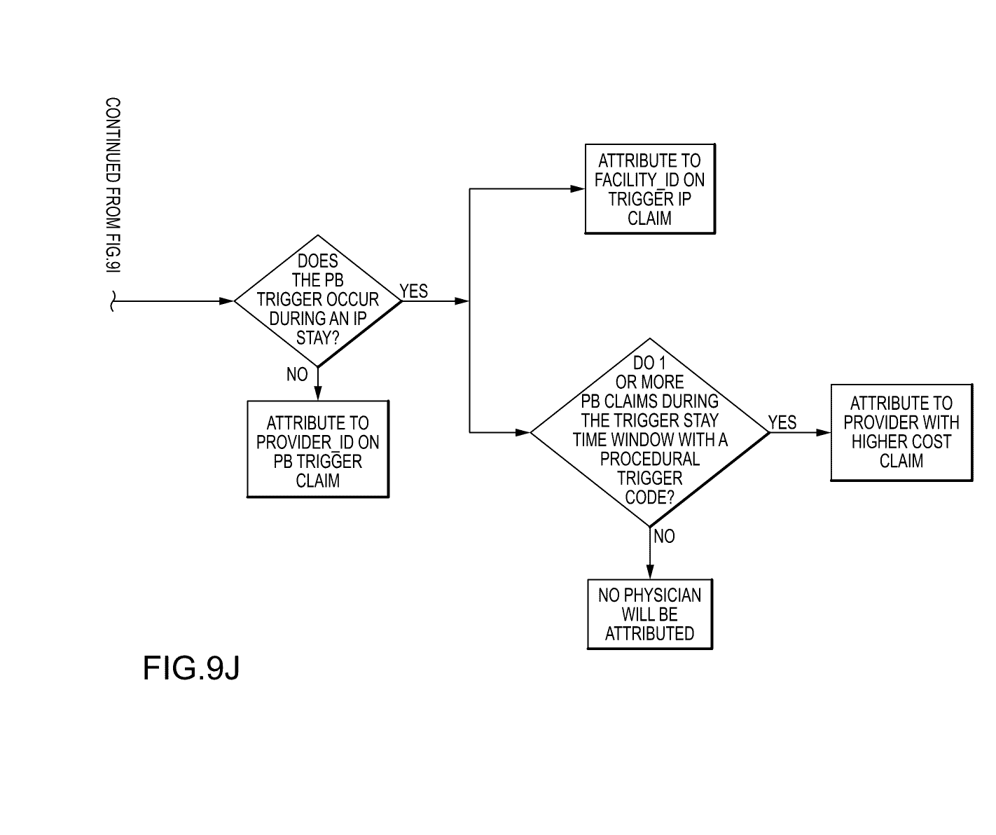

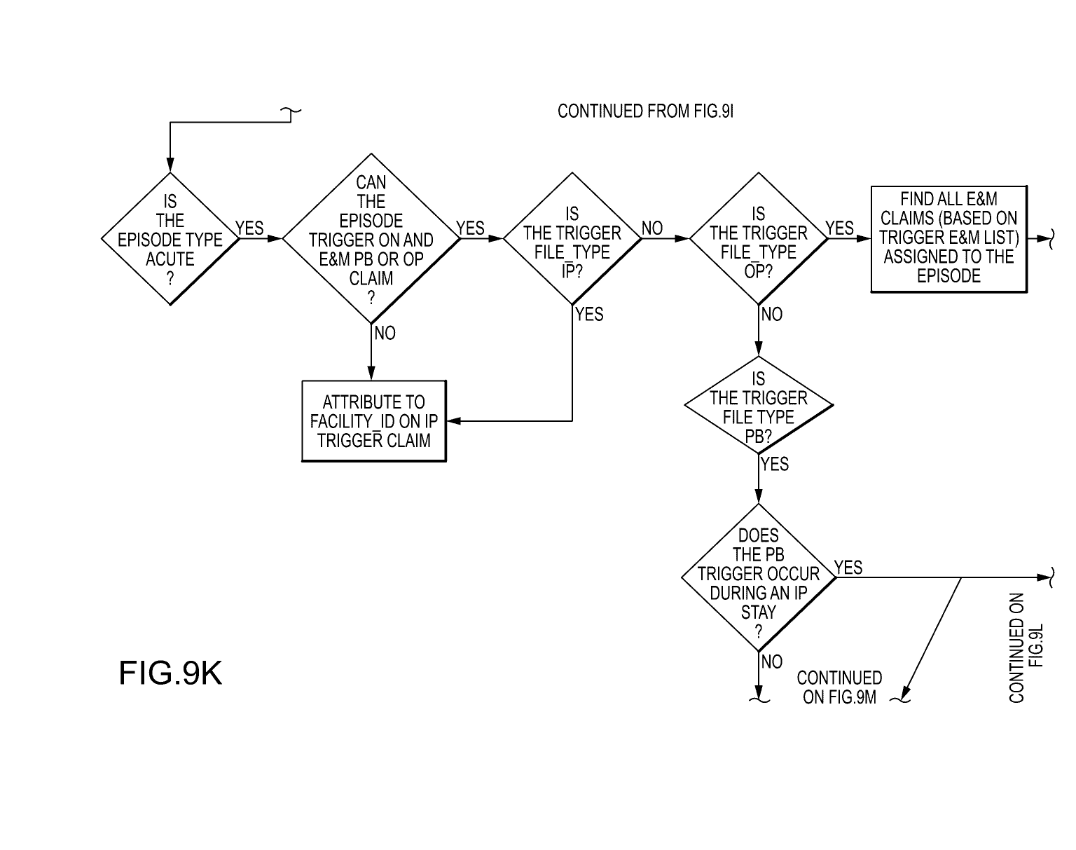

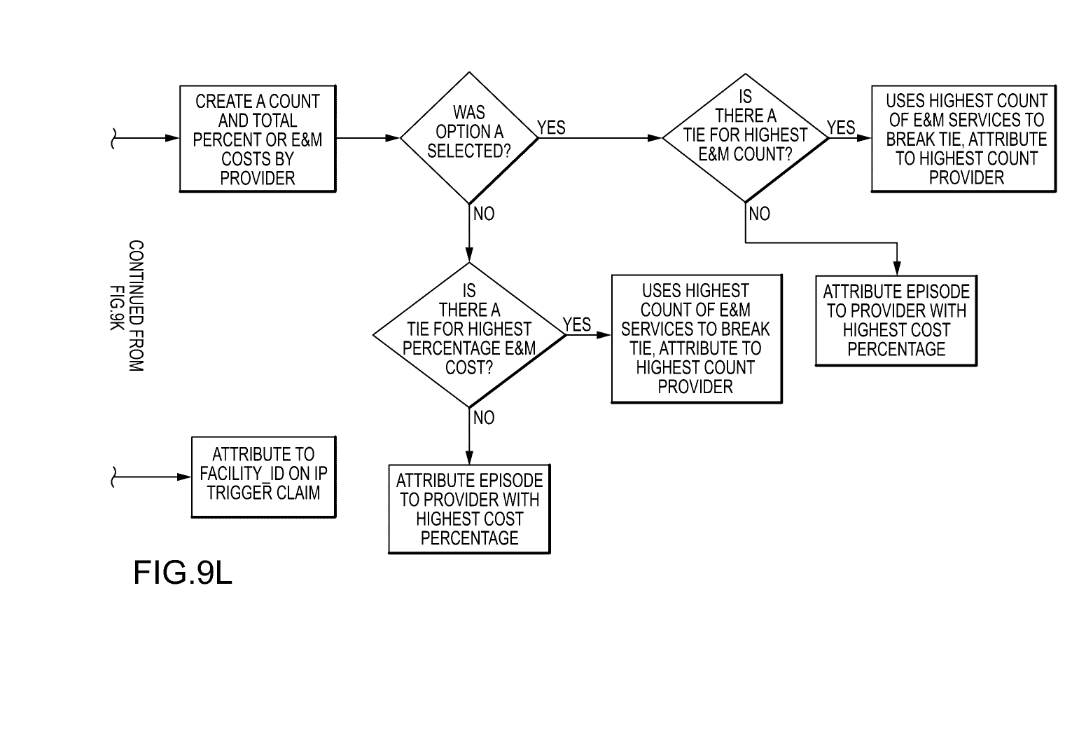

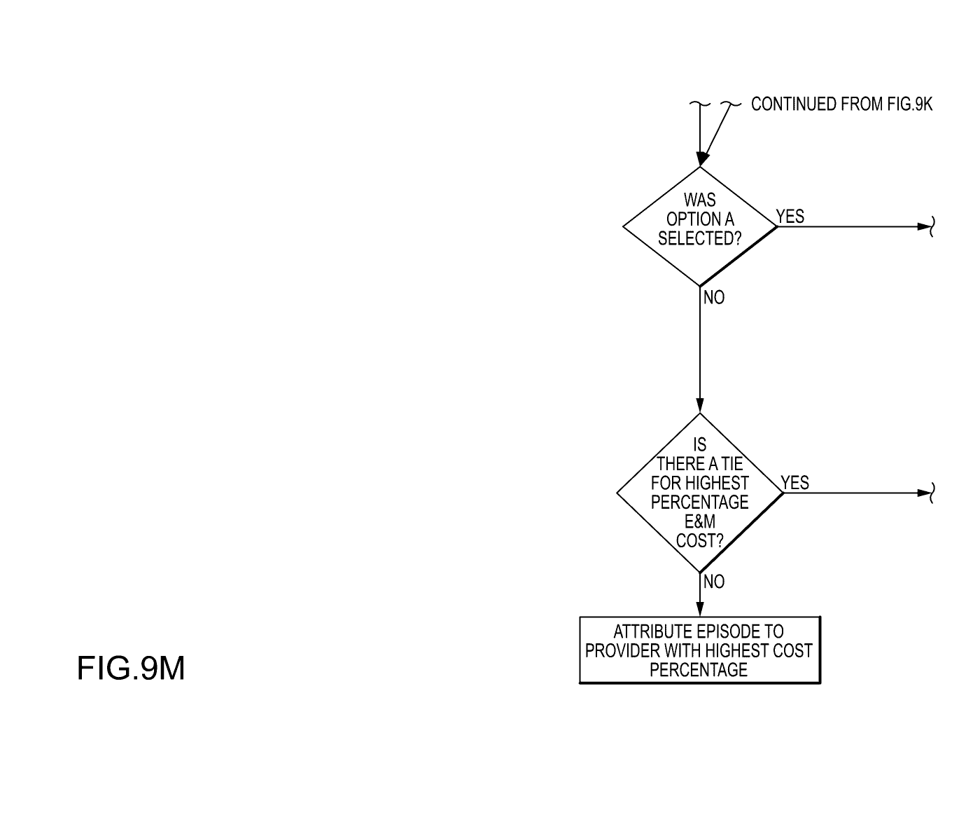

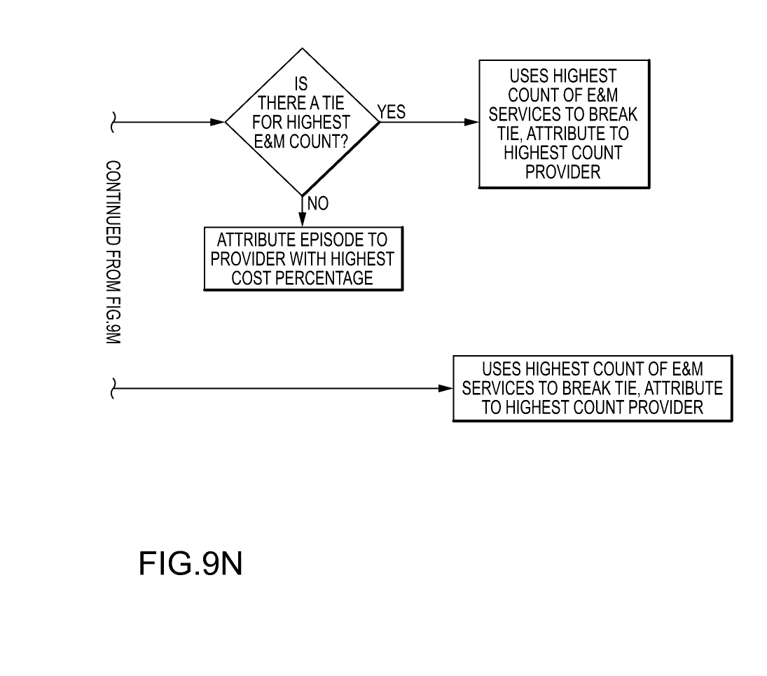

FIGS. 9A-9N is a flow chart illustrating the process of attributing episodes to providers in accordance with an embodiment of the present invention. Users have the option of selecting forced attribution and to which episode types forced attribution should be applied.

### Forced Attribution Option

Users should have the option of selecting any field from the member file for forced attribution. The user would need to select forced attribution, then select to which episode types (chronic, procedural, acute, other) forced attribution should be applied, and then specify which field they want to use for attribution.

The customer can choose to assign providers based on “hard-coded” data provided in the member file that is not dependent on claims. Forced attribution assigns the member to a single provider defined in the select field in the member file

### Semi Forced Attribution Option

Users can also choose to force attribute to a primary care physician (PCP) listed in the enrollment file (Semi Forced Option). The person's PCP may change over the course of the study period, based on enrollment periods. A person could have different PCPs for each enrollment period specified in the enrollment file. The following five options are available for assigning a patient to their PCP.

### Semi Forced Attribution Options/Methodology:

A. Attribute patients to the PCP (indicated in the member eligibility file) with the highest number of E&M visits. “E & M” is a regular professional services claim that has CPT codes that indicate that the patient was “evaluated and managed.” There are a number of procedure codes that broadly are designated as E&M and these are used to determine which physician has had his/her hands on the patients more times than others.
   a. Find all E&M claims (based on the trigger E&M list) for the providers in the patient PCP field of the enrollment file for the entire study period.
   b. Create a count and total E&M cost for each PCP.
   c. Attribute all episodes to the provider(s) with the highest count of E&Ms.
      i. If there is a tie, attribute to the provider with highest E&M costs.
B. Attribute patients to the PCP (indicated in the member eligibility file) with the highest E&M costs.
   a. Find all E&M claims (based on the trigger E&M list) for the providers in the patient PCP field of the enrollment file.
   b. Create a count and total E&M cost for each PCP.
   c. Attribute all episodes to the provider(s) with the highest cost of E&Ms.
      i. If there is a tie, attribute to the provider with highest E&M count.
C. Attribute patients to the PCP (indicated in the member eligibility file) who covers the longest period of time during the episode.
   a. Based on the enrollment periods assigned to each provider and the episode time window, determine which PCP in the patient PCP field the patient was attributed to for the highest number of days during the episode time window and assign to that provider.
D. Attribute patients to the PCP (indicated in the member eligibility file) they are assigned at the beginning of the episode.
   a. Assign each episode to the PCP from the patient PCP field in the enrollment file whom the patient was attributed to in the enrollment file at the time of the episode trigger.
E. Attribute patients to the PCP (indicated in the member eligibility file) they are assigned when the episode ends.
   a. Assign each episode to the PCP from the patient PCP field in the enrollment file whom the patient was attributed to in the enrollment file at the time the episode ended.

### Procedural Options

Procedural episodes will not have an option to select attribution to the facility or to the physician since the provider attribution outputs will automatically give both for these episode types.

### Procedural Attribution Methodology:

A. If the episode triggers on an inpatient claim:
   a. Attribute to facility_id and provider_id on the trigger IP claim.
   b. If there is no provider_id on the trigger IP claim, attribute to provider_id using the following method:
      i. Identify all relevant professional claim lines with a service from date that occurs during the IP trigger claim (admission through discharge dates) and a procedural trigger code for the episode.
      ii. If there are 1 or more professional claim lines with a procedural trigger code during the IP trigger claim admission through discharge dates, attribute to the provider_id with the highest professional claim line cost.
B. If the episode triggers on an outpatient claim:
   a. Attribute to the facility_id and provider_id on the trigger outpatient claim.
   b. If there is no provider_id on the trigger OP claim, attribute to provider_id using the following method:
      i. Identify all relevant professional claim lines with a service from date that occurs during the OP trigger claim (admission through discharge dates) and a procedural trigger code for the episode.
      ii. If there are 1 or more professional claim lines with a procedural trigger code during the IP trigger claim admission through discharge dates, attribute to the provider_id with the highest professional claim line cost.
C. If the episode triggers on a professional claim line:
   a. Attribute to the provider_id on the trigger professional claim line.
   b. To attribute the episode to a facility_id, use the following method:
      i. Identify all relevant Inpatient claims with admission through discharge dates that overlap with the trigger professional claim line's service from date. If there is more than one IP claim that meets this criterion, attribute to the facility_id of the first IP claim in the sequence.
      ii. If there are no relevant inpatient claims that overlap with the trigger professional claim line, identify all relevant Outpatient claims with service from and through dates that overlap with the trigger professional claim line's service from date. If there is more than one OP claim that meets this criterion, attribute to the facility_id with the highest OP claim cost.

### Acute Options

If an Acute episode triggers off of an inpatient facility claim, the episode is attributed to the facility. Otherwise, the user will need to select an option for acute episodes that trigger off of a professional or outpatient facility claim. Users will need to select how they want the episode assigned according to the attribution types listed below.

### Attribution Type (Cost/Frequency)

For Acute episodes triggered off a professional or outpatient claim, choose one of the two attribution rules that follow:
A=Attribute ECRs to physicians based on the highest number of office visits.
B=Attribute ECRs to physicians based on total relevant E&M costs.

By default, the Acute ECRs are attributed based on the highest number of office visits.

### Minimum Number of Office Visits

For Acute ECRs, if the attribution is based on the number of relevant visits, enter the minimum number of relevant visits that qualifies the physicians for attribution. The default minimum number of relevant visits is 1 (one-touch).

### Minimum Percentage of Costs

For Acute ECRs, if the attribution is based on the cost of relevant E&M visits, enter the minimum percentage of relevant E&M costs that qualifies the physicians for attribution. The default minimum percentage of relevant E&M costs is 30%.

Still referring to FIGS. 9A-9N, the methodology for attribution of acute episodes in one embodiment is as follows:

### Acute Attribution Methodology

A. If the episode triggers on an inpatient claim.
   i. Attribute to facility_id on the trigger IP claim.
   ii. To attribute to a provider_id, use the following method:
      1. Create a count and percent of total professional claim line E&M costs for each provider.
      2. Option A:
         a. Find all providers that meet the minimum number of E&M services specified and attribute to the provider with the highest E&M count.
         1. If there is a tie, attribute to provider with highest percentage of total E&M costs.
      3. Option B:
         a. Find all providers that meet the minimum percentage of E&M costs and attribute to the provider with the highest percentage of E&M costs.
         1. If there is a tie, attribute to provider with highest E&M count.
B. If the episode triggers on an Outpatient claim.
   i. Attribute to facility_id on the trigger OP claim.
   ii. To attribute to a provider_id, use the following method:
      1. Create a count and percent of total professional claim line E&M costs for each provider.
      2. Option A:
         a. Find all providers that meet the minimum number of E&M services specified and attribute to the provider with the highest E&M count.
         1. If there is a tie, attribute to provider with highest percentage of total E&M costs.
      3. Option B:
         a. Find all providers that meet the minimum percentage of E&M costs and attribute to the provider with the highest percentage of E&M costs.
         1. If there is a tie, attribute to provider with highest E&M count.
C. If the episode triggers on a professional claim line:
   i. If the professional claim line occurred during an inpatient stay attribute to facility_id on the overlapping IP stay.
   ii. If the professional claim line occurred during an outpatient encounter attribute to facility_id on the overlapping OP encounter.
   iii. To attribute to a provider_id, use the following method:
      1. Create a count and percent of total professional claim line E&M costs for each provider.
      2. Option A:
         a. Find all providers that meet the minimum number of E&M services specified and attribute to the provider with the highest E&M count.
         1. If there is a tie, attribute to provider with highest percentage of total E&M costs.
      3. Option B:
         a. Find all providers that meet the minimum percentage of E&M costs and attribute to the provider with the highest percentage of E&M costs.
         1. If there is a tie, attribute to provider with highest E&M count.

### Chronic/Other Condition Options

### Attribution Type (Cost/Frequency)

For chronic ECRs, choose one of the two attribution rules that follow:
A=Attribute ECRs to physicians based on the highest number of office visits.
B=Attribute ECRs to physicians based on total relevant E&M costs.

By default, the chronic ECRs are attributed based on the highest number of office visits.

### Minimum Number of Office Visits

For chronic and other condition ECRs, if the attribution is based on the number of relevant visits, enter the minimum number of relevant visits that qualifies the physicians for attribution. The default minimum number of relevant visits is 1 (one-touch).

### Minimum Percentage of Costs

For chronic and other condition ECRs, if the attribution is based on the cost of relevant visits, enter the minimum percentage of relevant costs that qualifies the physicians for attribution. The default minimum percentage of relevant costs is 30%.

### Single or Multiple Attribution

For chronic and other condition ECRs, choose the attribution rule that determines whether episodes will be attributed to single (plurality rule) vs. multiple providers.

A=Plurality Attribution: If the user opts to attribute episodes to providers that meet the minimum number of office visits, attribute each episode only to the single physician with the highest number of office visits. If there is a tie among physicians, that is if more than one physician has the highest number of office visits, attribute the episode to the physician with the highest total relevant E&M costs for the episode. If the user opts to attribute episodes to providers that meet the minimum total relevant E&M costs, attribute each episode only to the single physician with the highest total relevant E&M costs for the episode. If there is a tie among physicians, that is if more than one physician has the highest total relevant E&M costs, attribute the episode to the physician with the highest number of office visits.

B=Multiple Attribution: If the user opts to attribute episodes to providers that meet the minimum number of office visits, attribute each episode to any physicians that meet the minimum office visit criteria. If the user opts to attribute episodes to providers that meet the minimum total relevant costs, attribute each episode to any physicians that meet the minimum total relevant E&M costs for the episode.

By default, the chronic/other ECRs are attributed based on the plurality rule.

### Chronic/Other Attribution Methodology

For chronic/other condition ECRs the attribution methodology is as follows (here the system attributes chronic/other episodes to provider_id only, not facility_id.)
A. Find all professional E&M claims (based on the trigger E&M list) assigned to each episode.
B. Create a count and percent of total E&M cost for each provider.
   a. Option A:
      i. Find all providers that meet the minimum number of E&M services specified.
         1. If multiple attribution was selected attribute to each provider that meets the minimum number of visits.
         2. If single attribution was selected.
         a. Find the provider with the highest E&M count.
         i. If there is a tie, attribute to provider_id with highest percentage of total E&M costs.
   b. Option B:
      i. Find all providers that meet the minimum percentage of E&M costs.
         1. If multiple attribution was selected attribute to each provider that meets the minimum percentage of E&M costs.
         2. If single attribution was selected.
         a. Find the provider with the highest percentage of E&M costs.
         i. If there is a tie, attribute to provider with highest E&M count.

### Severity and Risk Adjustment

In accordance with an embodiment of the present invention after the episodes have been attributed to the providers, there is a severity and risk adjustment process to allow for the calculation of fair and credible expected costs that can then be applied to two specific “use” cases:
1. Create severity-adjusted for budgets based on the expected costs of typical services and complications; and
2. Create risk-adjusted measures that accurately reflect the performance of health care providers, such as providers and hospitals.

Because the methodology develops separate models for each use, the models used for budget creation have are referred to as “severity-adjustment” models and for provider performance measurement have been labeled as “risk-adjustment” models. The methodology for creating the two types of models is exactly the same except for defining the costs of claims assigned.

The severity and risk adjustment models within the ECR framework calculate expected costs of episodes of care based on individuals' characteristics, co-morbidities and severity of illness. The overarching goal of risk and severity adjustment is to predict expected costs for a patient using historical risk factors and episode-specific subtypes. The models are not intended to model clinical risk (except in the end-of-life model). Instead, they use patient information to adjust for patient-level factors that are known to result in variations in resource use.

Within the severity and risk adjustment there is: 1) provider performance measurement, 2) a price adjustment and 3) patient scoring. The purpose of a provider performance measurement is to measure/determine the performance of a provider. When comparing the performance of individual physicians, it is necessary to account for differences in their patient mix based on factors such as age, gender, severity of illness and comorbidities that may contribute to differences in outcomes and episode costs. Otherwise, providers that treat a sicker and more complex mix of patients will appear as poor performers even if they provide care efficiently while the inefficient providers treating healthier patients will appear as good performers.

To be able to fairly reward or penalize providers irrespective of the types of patients they treat, it is necessary to properly adjust for their case-mix differences when measuring their overall performance. Provider performance measurement is discussed in more detail below.

The price adjustment within the severity and risk adjustment step is to account for variations in fee schedules and the reimbursements paid across different providers in order to reduce the potential to distort episode costs. Price adjustment is discussed in more detail below.

Severity and Risk adjustment also involves Patient Scoring. The risk-adjustment process serves two important purposes within the ECR Analytics process. The first of these is for post-hoc performance reporting. Specifically, the process allows one to predict episode costs based on each individual's own demographic information (age, gender, etc.), co-morbidities and other prior conditions, and severity of illness. From these metrics provider performance can be compared in a way that accounts for differences in their patient populations, ensuring that the comparisons are fair and accurate. The second purpose of risk-adjustment is to use the expected costs of episode components to calculate budgets. Both these processes require the “application” of the risk adjustment coefficients or parameters to a patient's profile (patient scoring) to calculate the expected costs. Patient scoring is described in more detail below.

### Overview of the Methodology

### Cost Assignments

Different costs are modeled for each of the use cases mentioned in the previous section. For budget creation, severity adjusted expected episode costs are modeled using the split costs to avoid double-counting service level costs across multiple episodes to which they are assigned. For provider performance measurement, risk adjusted expected episode costs are modeled using the actual allowed amounts from the claims, allowing for service level costs to be fully accounted for in multiple episodes to which they are assigned.

### Defining the Model Period

While all risk and severity adjustment models are created separately for each episode, different model periods are used for each based on the defined length of the episode in days. For episodes defined as lasting more than 180 days, the model period is based on a rolling 6-month period beginning on the episode start date. For episodes defined as lasting 180 days or less, the entire episode length is used as the model period.

### Model Creation Process

An example of the process used to create risk and severity adjustment models is as follows:
1. Expected estimates are created for episodes using the member's risk adjustment information, obtained from the member files and all diagnostic codes in the claims. Risk adjustment information is updated for each 6-month increment for episodes lasting longer than 180 days.
2. The risk and severity-adjustment models are created in several distinct steps:
   a. A probability estimate is created using a logistic regression model for “end-of-life” and this variable is included in both sets of regression models used to develop the risk adjusted expected costs
   b. The cost estimates are created through a multi-step approach, wherein expected costs are calculated conditional on the probability of incurring costs. The steps involved are as follows:
      i. Creating a Probability of Use model: The estimated likelihood of the member having a non-zero positive expected cost derived from another logistic regression model; and
      ii. Creating an Expected Cost model: The estimated magnitude of the expected cost derived from a linear regression model, for all claims with non-zero positive costs.
      iii. The probability of use from the logistic regression model is multiplied by the expected costs from the linear regression model to calculate the expected costs for the episode component for the model period
3. Multiple components of the episode are modeled separately:
   a. For “end-of-life” model—a single logistic regression model is created for each episode or episode 6-month increment
   b. For cost models, separate use and cost models are created for distinct cost components of the episode or episode 6-month increment:
      i. Episodes>180 days:
         1. Total Typical Costs include all inpatient, outpatient, professional, ancillary, and pharmacy typical costs;
         2. Complications costs include all inpatient, outpatient, professional, ancillary, and pharmacy costs labeled as “complications”.
      ii. Episodes≦180 days:
         1. Typical inpatient facility costs include all inpatient facility costs labeled as “typical” (inpatient facility claims and costs labeled typical with complications—labeled “TC”—are excluded from the models)
         2. Typical “professional and other” costs include outpatient facility, professional, ancillary, and pharmacy costs labeled as “typical” (costs labeled typical with complications—labeled “TC”—are excluded from the models)
         3. Complication costs include all inpatient, outpatient, professional, ancillary, and pharmacy costs labeled as “complications”.
4. Assembling the pieces to create the final expected costs
   a. For Budget Creation purposes: Expected “Typical” costs are assembled separately from expected “Complication” costs
   b. For episodes longer than 180 days, the expected episode costs are summed across the first two model periods to calculate annual expected costs

All models are run independently. The cost and use models for each episode are run for each level of association since claims, costs, and assignments are re-determined and re-assembled at each episode level. The end-of-life models only need to be run once for each episode.

### Creation of the Period Summation Files

Period summation files are created for each episode. These files serve as the input data files for the risk and severity adjustment process and contain all relevant patient risk factors and outcome variables serve as the input data files for the risk and severity adjustment process. Each of the input data files includes various data elements such as episode information, patient information, risk factors, episode subtypes, dependent variables (end of life indicator, use indicator, actual allowed amount costs, split costs), typical inpatient facility cost only indicator, and threshold indicator.

### Defining the Units of Analysis in the Period Summation Files

The units of analysis in the period summation files are defined as follows: Each row in the data files will indicate a single unit of analysis for modeling expected costs based on the type of episode. For episodes that are ≦180 days, each unit of analysis, or row, in the data files correspond to a single episode as defined by the episode start and end date. For episodes>180 days each unit of analysis, or row, in the data file corresponds with each 6 month increment of a single episode beginning with the start date of the episode. Because these episodes can trigger at different times, different episodes will have different numbers of observations. For example, to illustrate, for a study period spanning a two-year period, a diabetes episode starting on day one of the study period will have four rows in the data file, one for each 6-month period observed for the episode. An episode triggering in the final half of the study period, however, would only have two observations covering the final two 6-month periods.

For budget calculations, patients with missing data are excluded from the modeling exercise. All data elements described above are combined into the period summation file and there should be a unique file for each episode.

### Risk/Severity Adjustment Modeling Process Overview

The risk/severity adjustment models are designed as mathematical models to develop expected values, thus one does not have to be as careful about multi-colinearity or as selective about which risk/severity factors to keep in the models and which to drop. For example, if two associated risk factors provide a better explanation of costs than either one alone, it is better to include them both when they are used together, even if both appear as not significant. The modeling process is carried out twice, once for the purposes of performance measurement using the actual allowed amounts and a second time for budget creation using the split costs.

A statistical software package is necessary to complete the risk/severity adjustment process. The ECR. Analytics may employ the R statistical package. The Period Summation Files are imported into the program to run the models and generate outputs.

### Model and Variable Set Up

Prior to the modeling process, the following criteria below are applied universally to all the models (e.g., EOL, probability of use, and costs).
1. Only episodes within the cost threshold (cost threshold indicator equal to 1) are included in the modeling process.
2. After applying the cost threshold, models are created for an episode only if there are at least 25 episodes.
3. Individual risk factors and subtypes that do not meet the following criteria are excluded from the models:
   Risk factors and subtypes that are flagged in five or fewer episodes.
   For logistic regression models (EOL and Probability of Use Models), if a risk factor or subtype is always associated with the same outcome. For example, all patients with a given risk factor died, or all lived.

### Creating “End-of-Lift” (EOL) Logistic Regression Models

The purpose of the “End-of-Life” (EOL) Logistic Regression Models is to predict each member's probability of death during the episode period using their available risk factors (e.g., age, gender, etc.). These estimates are then used as covariates in the “use” models and the cost models. A separate single model is run for each episode or 6-month episode increment. These apply to all levels of association.

EOL Logistic Regression Models are run for each episode or episode increment. For episodes≦180 days, a single model is used for the entire episode period. For episodes>180 days, separate models are run for each 6-month increment to allow for inclusion of the most current set of risk factors.

The following variables are included in the EOL Logistic Regression Models:
Dependent variable: The “end-of-life” indicator (0/1);
Independent variables: age, gender, recent enrollee status, the relevant risk factors, and episode subtypes.

The outputs from the EOL Logistic Regression Models display the coefficients for each risk factor and its contribution towards estimating a probability of end-of-life for each episode or episode 6-month increment period. These outputs should also list any relevant error messages generated by the statistical program. If a model did not converge, EOL probabilities are not estimated.

The end-of-life model coefficients are used to generate a probability score for each member for each episode. The probability scores are merged into the input files for the “use” models and for the cost models, using the episode ID, and serve as an additional risk factor in the cost and use models at each level of association. The same EOL probability score is used for both the performance measurement and the budget calculations.

### Creating Expected Cost Models

A multi-step process is employed to arrive at expected costs. Two distinct regressions are run for each model episode component dataset: 1) a probability of “use” logistic model to estimate the probability of an episode component having positive non-zero costs and, for episode components with positive costs; 2) a linear model of the expected costs for the episode component. The estimates from these models are then combined to arrive at the conditional expected costs.

After merging in the EOL probabilities from above for each episode the resulting data files are imported into the user's preferred statistical package. This file can be used for both the use and cost models.

### “Probability-of-Use” Logistic Regression Models

The “Probability-of-Use” Logistic Regression Models are used to predict the probability an episode will have non-zero costs for each type of cost, e.g. typical, complications.

Separate logistic regressions are run for each component of the episode or episode 6-month increment period at each level of association. For episodes≦180 days, three use models (typical inpatient facility costs, typical professional and other costs, and complication costs) are created for the entire episode period for each level of association. For episodes>180 days, two models (typical costs and complication costs) are run for each 6-month increment and at each level of association.

The following variables are included in the “use” logistic models:
Dependent variable: the “use” indicator for the specific cost component being modeled (i.e., typical inpatient facility costs, complication costs, etc.)
Independent variables: age, gender, recent enrollee status, relevant risk factors EOL probability, and relevant risk factors, and episode subtypes.
   Regression models are only kept if the maximum likelihood estimation converges.

The outputs from the logistic regressions are used to estimate a probability of non-zero costs for each component of the episode or episode increment included in the models. If a model did not converge, no probability of use is calculated.

### Running the Cost of Care Linear Regression Models

Separate linear regressions models are run to estimate the expected costs for each cost component of the episode or 6-month increment at each level of association.

For episodes≦180 days, three cost models (typical IP facility costs, typical Professional and other costs, and complication costs) are created for each component of the episode for each level of association. The typical inpatient facility cost models only include episodes with “typical” IP facility costs and exclude episodes containing typical-complication costs. This can be identified through the Typical IP facility cost only indicator.

For episodes>180 days, two models (typical costs and complication costs) are run for each 6-month increment at each level of association.

The following variables are included in the cost linear regression models:
Dependent variable: Typical and complication cost component. For the performance measurement models, these are based on the allowed amounts from the actual claims. For the budget creation models, these are based on the split costs calculated during episode construction.
Independent variables: age, gender, recent enrollee status, EOL probability, relevant risk factors, and episode subtypes.

Regression models are only kept if the model includes at least three independent variables and has an adjusted R-squared value of 0.1 or greater. Otherwise, predicted costs are not calculated.

### Consolidating the Estimates

The estimates from the (1) “Probability-of-Use” Logistic Regression Models and (2) Cost of Care Linear Regression Models, are then consolidated to arrive at the conditional expected costs. Using the coefficients from the “use” models, predicted probabilities of use are calculated for all episodes, for each cost component and at each level of association. If a specific model experience an errors—for example, the model did not converge—then no probability of use is calculated for that cost component at that level of association.

Using the coefficients from the cost models, expected costs are calculated for each member for each episode, for each type of cost, and at each level of association. Expected costs are calculated for all episodes even those excluded from the cost models (i.e., had typical-complication costs).

The predicted costs of each component are then multiplied by their corresponding probabilities of use to get the expected cost conditional on use for each episode at each level of association. These are the final estimated episode costs for each cost component.

The conditional expected costs for each cost component are added to obtain the total expected episode cost for each episode at each level of association. For episodes≦180-days, conditional expected typical IP facility, typical professional and other, and complication costs are added to get the total conditional expected episode costs. For episodes>180 days, conditional expected typical and complication costs for each 6-month increment are added to get the 6-month total episode conditional expected costs. Annualized costs are calculated using the first two 6-month model periods. These calculations are the same for both the budget creation and provider performance use cases.

### Output Tables

A set of output files are created from the risk and severity adjustment models for each episode:
1. Frequencies file: Contains the descriptive statistics (e.g., means, frequencies, etc.) for the model covariates of each episode. Also includes t-values and significance tests.
2. Parameter files: Contain the model coefficients for the EOL, use, and cost models for each episode. The files for the use and cost models should include the model coefficients for each level of association.
3. Severity and Risk Adjusted Costs: Contain the estimated probabilities from the use models, the conditional risk and severity-adjusted costs from the conditional cost models, and the observed costs.

No specific file layouts are prescribed for the frequency and parameter tables so that users can customize them to meet their own internal needs for assessing the detail and robustness of the models. For example, in addition to the coefficients, users may opt to include goodness-of-fit measures, such as the R-squared statistic.

### Provider Performance Measurement

When comparing the performance of individual physicians, it is necessary to account for differences in their patient mix based on factors such as age, gender, severity of illness and comorbidities that may contribute to differences in outcomes and episode costs. Otherwise, providers that treat a sicker and more complex mix of patients will appear as poor performers even if they provide care efficiently while the inefficient providers treating healthier patients will appear as good performers.

To be able to fairly reward or penalize providers irrespective of the types of patients they treat, it is necessary to properly adjust for their case-mix differences when measuring their overall performance. The steps below describe the process for calculating case-mix adjusted provider performance scores.

Process Set-Up

After episodes have been built through the ECR Analytics process, risk-adjusted expected costs are calculated, and episodes are attributed to providers. At this point, we can measure the performance of providers and compare them with others. For the provider measurement program, we use the allowed amounts on claims as a surrogate for costs, and if the claim is multi-assigned to concurrent episodes, we take the full claim cost double-counted into concurrent episodes.

At the time of provider performance measurement, users should be able to determine which episodes to create performance comparisons for. In other words, they could compare provider performance for all, some, or none of the selected episodes based on their needs. They should be able to choose (“toggle”) by a Yes/No function.

### Overview of Methodology

Provider Performance Measurement involves the following steps:
1. Determining which Providers could undergo Performance Measurement Comparisons
2. Calculating a Risk Score/Case-Mix Index at the provider level
3. Applying the Risk Score/Case-Mix index to expected costs to arrive at case-mix adjusted costs for the provider
4. Calculating a Performance Score for each provider

### Process Specifications

This process applies to all episodes chosen by the user for provider performance comparisons.

Determining which providers can undergo Performance Comparisons—Only providers with 25 or more attributed episodes are to be included in the performance measurement calculations.

ECR Platform and Data Input—The performance measurement application is applied after risk-adjustment is done. The inputs for this program requires claims data to be first processed as follows. Claims are first processed through the ECR Analytics (V5.0) Clinical and Construction logic and “actual” episode costs are calculated. Episodes constructed in the previous step are then passed through the risk-adjustment process and “expected” full episode costs are calculated. Next, episodes are attributed to providers using the Provider Attribution process and both actual and expected costs are carried forth for each provider for the episodes that are attributed to them.

Creating the Analytic File—Using the outputs of the risk-adjustment and provider attribution processes, a data file must be created that includes actual average total episode costs and “expected” average total episode costs for each provider that meets the minimum number of episodes. Separate files are created for each episode type selected for provider performance comparisons. See the file layout below for a list of the specific fields.

Calculating a Risk Score/Case-Mix Index—Each provider is assigned a risk score or case-mix index by calculating the ratio of their individual average “expected” total episode costs to the average expected total episode costs across all providers. For example, if a provider's average “expected” episode costs for a knee arthroscopy episode are $8,000 and the overall average across all providers for knee arthroscopy episodes is $10,000, the provider's case-mix index will equal 0.80.

Calculating the Case-Mix Adjusted Provider Episode Costs—The risk index from Step 4 is multiplied by the provider's “actual” average total episode costs, giving the case-mix-adjusted average total episode costs for the provider.

Calculating the Provider Performance Score—Provider performance scores are calculated by dividing each provider's risk-adjusted average total episode costs by the average total episode costs across all providers. This calculation is mathematically the same as Step 4 except that case-mix-adjusted average total episode costs are used instead of the expected costs.

Output Data—The resulting data files from the provider performance reporting process are simply the data files created in Step 3 plus the calculated fields described in Steps 4 and 5. Specific fields are listed in detail below. A file should be created for each episode chosen by the user for price-adjustment.

### Patient Scoring To Calculate Expected Costs of Future Episodes

The primary purpose of risk-adjustment is to use the expected costs of episode components to calculate budgets. For these processes the risk adjustment coefficients or parameters are applied to a patient's profile to calculate the expected costs. The process is referred to as “episode/patient scoring”.

Simply stated, the risk-adjustment process is the development of an algebraic equation that predicts some outcome of interest (e.g., episode costs). This equation is based on a given set of data and a pre-determined list of variables, or “risk factors” (demographic information, co-morbidities, severity of illness), that are known to be correlated to episode costs. Through a statistical process referred to as “regression modeling” the data is used to produce a mathematical equation that most closely predicts the outcome of each episode. Stated differently, regressions find a single equation that best minimizes the difference between the actual observed episode costs and the episode costs as predicted by the equation.

The equation itself is an algebraic equation that includes a coefficient for each variable included in the model. These coefficients are equal to the average contribution of a particular variable/risk factor to the outcome being predicted.

A useful application of this process is that, once the equations are produced, it allows one to predict or “score” episode costs for virtually any episode. This includes any new episodes that may be triggered outside of those used for the regression process.

For the purposes of episode scoring, the ECR Analytics risk adjustment process is actually a combination of two different models:
1. Probability of Use Model—These models predict the probability that an episode component had costs greater than $0. Since the ECR risk adjustment process estimates different types of costs within each episode (i.e., typical and complications it is possible that some episode components have costs=$0. These models are only run if at least 10% of episodes have costs=$0.
2. Predicted Costs—These model predict costs for each category of costs (i.e., typical and complications) within the episode.

When a new episode is triggered, the patient's demographic and risk factor information will be brought in from the member file and their historical claims. Then, this information is applied to the model coefficients from both models to calculate probabilities of use and predicted costs for each cost component. Once these are calculated, this information is combined and summed to get the expected episode costs.

### Price Adjustment

Variations in fee schedules and the reimbursements paid across different providers have the potential to distort episode costs. This is because it is difficult to separate high episode costs due to higher resource use from high episode costs due to higher prices. Price differences also lead to wide differences between a provider's observed episode costs and their episode budgets. As a result, this can introduce unwanted incentives that may either encourage or discourage certain providers from participating in bundled payment programs.

It is important to note that there are multiple ways to account for the variability in prices on episode costs. One way is to set a fixed or standardized price for every individual type of service relevant to the episode. Essentially, this method assigns the same price for each unique type of service regardless of the provider, so that the only episode cost differences that remain are those that are due to utilization (number and type of services). To do this, however, requires that every single type of service can be identified through a unique code. For some claims, such as physician services or prescriptions, this could be done relatively easily through the related CPT or NDC code. This may also be possible in the case of inpatient stays through the use of DRGs. However, the inventors have discovered that DRG assignment to stays is often not based on clinical optimization of the hospitalization event, but instead on a hospital specific algorithm that maximizes financial gain. Hence, the ECR Analytics software does not rely on the use of the DRG to classify stays, and use of DRGs to standardize prices for stays would perpetuate the behavioral distortions in the status quo. Therefore, the next best approach is to try and adjust for price differences between providers as much as possible by targeting those episodes and services that matter the most when creating the episode budgets.

Because of the necessity to account for price differences when creating budgets, and considering the challenges associated with fully standardizing costs in the absence of a common identifier for inpatient stays, the steps below describe the approach HCI3 has developed to price adjust budgeted amounts in the ECR Analytics. Specifically, this method creates provider-specific price indices and applies them to episodes that trigger through high cost IP stays or high cost procedural CPT codes. This is an attempt to create price-adjusted budgets, in accordance to the fee schedules of the providers, for the episodes that are attributed to them.

After episodes have been built through the ECR Analytics process, severity-adjusted expected costs are calculated, and episodes are attributed to providers. At this point, episode budgets are created prospectively for future episodes for each provider.

The price adjustment methodology is a multi-step process: Determining which episodes should undergo price adjustment, Create the input files, calculating a Price Index and Applying the price index to various components of the severity-adjustment outputs that could serve as inputs for Budget Creation

ECR Platform and Data Input

The price-adjustment application is applied prior to budget creation. The inputs for this program require claims data to be first processed as follows:
a. Claims are first processed through the ECR Analytics (V5.0) Clinical and Construction logic and “actual” episode costs are calculated.
b. Episodes constructed in the previous step are then passed through the severity-adjustment process and “expected” typical and “expected” complication costs are calculated.
c. Next, episodes are attributed to providers using the Provider Attribution process and both actual and expected costs are carried forth for each provider for the episodes that are attributed to them.
3. Creating the Input Files for Price Adjustment
For each episode type that requires price adjustment, two sets of data files need to be created for the price adjustment process. Separate files are created for each episode chosen for price adjustment. Data File #1: This file will be used to calculate the Price Index. Data File #2 is used to apply the price index to the various components of the input fields for price adjustment of the budgets.

### Calculating a Price Index

Different costs are used to calculate the price index for different episodes:

All calculations for this section use Data File #1
a. Acute Medical Episodes: Only trigger stays for acute medical episodes that are flagged as “T” (typical trigger stays are used to calculate the price indices. “TC” (typical with complication) stays are not used for calculating the price index.
b. Procedural Episodes:
   i. For Procedural episodes attributed to Hospitals, the Trigger stays that are flagged as “T” (typical trigger stays are used to calculate the price indices. “TC” (typical with complication) stays are not used for calculating the price index.
   ii. For Procedural episodes attributed to surgeons, trigger CPT codes are used to calculate the price index.
c. Price indices are calculated at the provider level only for providers with 25 or more attributed episodes. This applies to each individual type of episode, not in total. Single providers are identified through their unique provider ID as defined by the user in the provider attribution module.
d. For all providers meeting the minimum threshold for attributed episodes, individual price indices for each provider are calculated as follows. The costs used will depend on whether the episode is an acute medical or procedural episode.
   Acute Medical Episodes: Ratio of each provider's average costs for trigger stays flagged as typical to the average costs of trigger stays flagged as typical across all providers.
   i. Procedural Episodes:
      Option 1: Ratio of each provider's average costs for trigger stays flagged as typical to the average costs of trigger stays flagged as typical across all providers.
      Option 2: Ratio of each provider's average costs for trigger CPT codes flagged as typical to the average cost of trigger CPT codes flagged as typical across all providers.
e. The price indices are the inputs used in the processes described in the next step to price-adjust expected costs.

### Applying the Price Index to the Expected Costs

All calculations for this section use Data File #2.
a. The price indices calculated from Step 4 above are combined with Data File #2. All indices should be matched on the Provider ID.
b. The expected costs that are price-adjusted for all episode types that require price adjustment using the method below:
   i. Provider Price indices are multiplied by the average expected typical costs for each provider, which yields the provider's price-adjusted average expected typical costs.
   ii. Provider Price indices are multiplied by the average expected complication costs, which yield the provider's price-adjusted average expected complication costs.
c. In cases where a provider did not have the minimum number of attributed episodes and, thus, did not have a price index calculated for them, then their average expected costs are simply carried over as their price-adjusted average expected costs.

In accordance with an embodiment of the present invention when the severity adjusted expected costs are calculated and the command to price adjust is received, the price may be adjusted with a calculated price index to differentiate between high episode costs due to higher resource use and high episode costs due to higher prices. Referring back to FIG. 1 and an embodiment of the ECR Analytics 10, if the user chooses to adjust prices 30, then there will be price adjustment 31. At the time of budget creation, users should be able to determine whether to adjust prices and which episodes they will price-adjust for. In other words, they could adjust expected costs for all, some, or none of the selected episodes based on their own needs. They should be able to choose (“toggle”) by a Yes/No function during the program set-up.

### Budget Creation

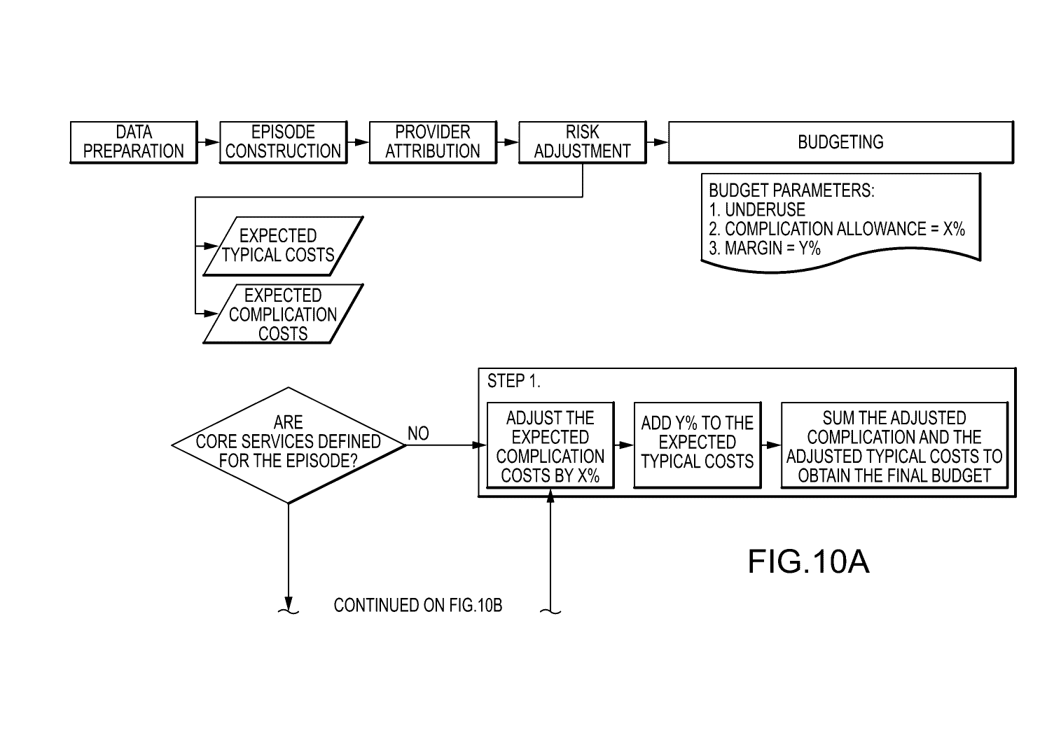

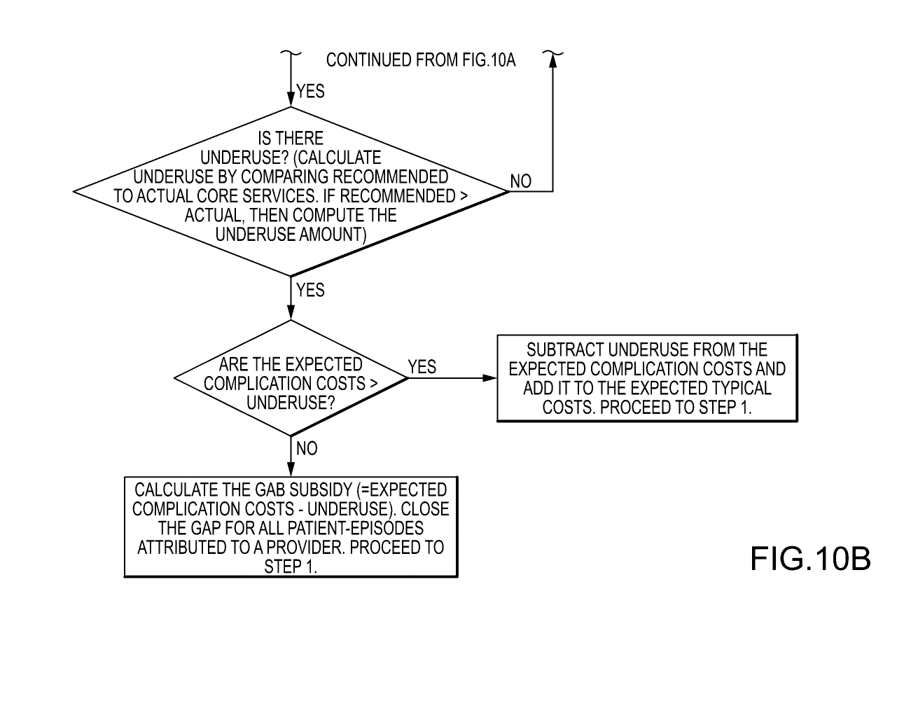

Referring back to FIG. 1 in accordance with an embodiment of the ECR Analytics 10 process there is a budget creation process 34 used to generate a budget to reflect the expected costs of typical care, expected cost of complications, underuse allowance, complications allowance, and/or a margin. FIGS. 10A and 10B are a flow chart illustrating the process of generating a budget from inputted data in accordance with an embodiment of the present invention.

To construct a budget for an episode of care, first several elements need to be defined and agreed upon by contract between the participating payer and provider. These elements include the payer business unit and the providers at risk under the bundle, identifying which episodes of care to contract, and whether payment will be applied prospectively or retrospectively. “Tunable parameters” also should be defined and agreed upon. “Tunable parameters” include for example, deciding if and how risk adjustment will be employed to create budgets, building in allowances for complications, considering a set margin opportunity, and creating stop loss corridors with possible withholds for downside risk. Once these elements have been defined, the budget can be calculated.

A prospective budget is constructed for each episode of care at each level of association for all eligible members. Budget creation must occur after provider attribution and risk adjustment as it employs outputs from each of those processes. In accordance with an embodiment of the ECR Analytics, specific defaults are set for each “Tunable parameter,” but these settings can be customized by the end user.

Once episodes have been attributed to the appropriate provider(s) and the risk adjustment models have been run, ECR Analytics leverages two outputs at all levels of association: (1) Expected Typical Costs; and (2) Expected Complication Costs. These two outputs may potentially be price adjusted, depending on user preference. Both of these outputs are adjusted according to the “Tunable parameters” to calculate the final budget. If core services have been defined for a particular episode, then ECR Analytics calculates an allowance for underuse and adjusts both the Expected Typical Costs and the Expected Complication Costs to ensure that any historical underuse is not cemented into the budget calculation. Next, Expected Complication Costs are adjusted to reflect the allowance for complications in the budget. Similarly, Expected Typical Costs are adjusted to incorporate any net-additive margin opportunity. The Final typical Budget is added to the Final Complication Budget to create the Final Total Budget for the episode.

The process for building in each of these adjustments is described below in more detail.

(1) Underuse Gap for Condition Episodes

“Underuse” is the difference between the recommended frequency of core services and the observed frequency of core services. Core services are identified by CPT codes and are flagged in the ECR metadata tables for each episode of care. Each core service CPT code rolls up to a core service category. Because the risk adjustment models create an expected value for typical care that is based on the historical observed use of typical services, it will “bake in” any observed underuse. The budgets are designed to ensure that typical services are budgeted at “full core capacity”. In other words, the budgets should not build in historical underuse they should be adjusted to ensure there are enough funds in the typical portion of the budget to cover the cost of recommended core services.

Increasing Expected Typical Costs by any amount would result in a net increase in total costs if it weren't offset. We offset the increase with a commensurate decrease in Expected Complications. The calculations below are designed to accomplish that task, taking into account the possibility that the Expected Complication Costs for an individual patient-episode does not fully cover the calculated increase in Expected Typical Costs. In those instances, there will be a remainder—a portion of the Underuse allowance to Expected Typical that is not covered by a commensurate reduction in Expected Complications—and that remainder is taken out of the balance of patient-episodes that have been attributed to a specific provider, for which there are still funds in Expected Complications Costs. The steps for closing the underuse gap are described below.

Step 1—Attribute episodes to providers.
Step 2—Calculate all models to arrive at Eceₙpₙ, Eteₙpₙ, where:
Eceₙpₙ=Expected cost of Complications for ECRn of Patient n
Eteₙpₙ=Expected cost of Typical care for ECRn of Patient n
   Step 3—Calculate the underuse for each eligible ECR of each patient, defined as Ueₙpₙ, where:
Ueₙpₙ=SUM[(Core Recommended for Service x−Core Actual for Service x)*Average Apportioned Amount for Service x] for all core services defined in an ECR
Average Apportioned Amount for Service x=SUM(Observed Apportioned Cost for Service x of ECRn across all patients)/Total Observed Number of Service x of ECRn across all patients
   Step 4—Close underuse gap per patient, by episode:
1. When Eceₙpₙ≧Ueₙpₙ:
   UAdjusted Eceₙpₙ=Eceₙpₙ−Ueₙpₙ
   UAdjusted Eteₙpₙ=Eteₙpₙ+Ue_{fl}pₙ
2. When Eceₙpₙ<Ueₙpₙ:
   UAdjusted Eceₙpₙ=$0
   UAdjusted Eteₙpₙ=Eteₙpₙ+Ueₙpₙ, and calculate the gap subsidy (Ueₙpₙ−Eceₙpₙ)
      Step 5—Determine the total gap subsidy for all episodes that have been attributed to a provider: SUM(Ueₙpₙ−Eceₙpₙ) for each ECR, only for patients for whom Eceₙpₙ<Ueₙpₙ.
      Step 6—Reduce the Eceₙpₙ for all ECRs on a proportional basis as illustrated in the table below:

| | Diabetes | CHF | . . . | Total |
|---|---|---|---|---|
| Total Balance | SUM(Adj | SUM(Adj | . . . | $xxxxxxx.xx |
| of Expected | Eceₙpₙ) | Eceₙpₙ) | | |
| Complications | | | | |
| Total Gap | SUM(Ueₙpₙ- | SUM(Ueₙpₙ- | . . . | $xxxxxxx.xx |
| Subsidy | Eceₙpₙ) | Eceₙpₙ) | | |
| % Reduction in | SUM(Ueₙpₙ- | SUM(Ueₙpₙ- | . . . | xx.xx% |
| Adjusted | Eceₙpₙ)/ | Eceₙpₙ)/ | | |
| Expected | SUM(UAdj | SUM(UAdj | | |
| Complications | Eceₙpₙ) | Eceₙpₙ) | | |

And apply ECR-specific % reduction to each AdjustedEceₙpₙ>$0.

### (2) PAC Allowance

A PAC Allowance is a contract parameter negotiated between the payer and the provider. It is expressed as a percentage and will be applied to Expected Complication Costs that have been determined for each patient-episode, after the Underuse Gap calculations have been performed. The net effect is a reduction in the Expected Complications for any patient-episode assigned to a specific provider.

There is a special category of complications—System-related Failures (SRFs)—that are assigned directly to a patient, and not attributed to an episode. The severity models do not calculate expected values for SRFs. As such they will always be historically observed costs assigned to a patient/patient population. Payers and Providers should negotiate a target reduction of SRFs, and providers would be at risk for any SRF costs that occur in the future that would be greater than the target. An allowance for SRFs can therefore be calculated (as a % of historical, the % being the negotiated target, e.g. 50% of past observed) and added back on a proportional basis to each patient-episode's Expected Complication Costs.

Step 1—Run the desired attribution model of patients to physicians and to rolled-up organizations as specified in the member and provider files.

Step 2—Determine the % reduction in AdjustedEceₙpₙ to be applied for each provider/provider organization (for any given episode):
Option A—same reduction for all providers: PACs Allowed per episode patient=(1−% reduction)*AdjustedEceₙpₙ
Option B % reduction specified by provider/provider organization: PACs Allowed per episode patient=(1−Provider-specific % reduction)*AdjustedEceₙpₙ, for each patient attributed to the Provider for which the Provider-specific % reduction applies.
   Step 3—Determine the allowance for SRFs:
SRF allowance=0%—no action
SRF allowance>0%
   Calculate total observed cost of SRFs across all patients attributed to a provider: CSRFprₙ=SUM(SRFpₙ) for patients attributed to provider n
   Apply negotiated allowance SRF % Allow to total observed CSRFprₙ and calculate AllowedCSRFprₙ=SRF % Allow*CSRFprₙ
Proportionally distribute and add back AllowedCSRFprₙ to each AdjustedEceₙpₙ for patients attributed to provider n ((AdjustedEceₙpₙ/SUM(AdjustedEceₙpₙ)*AllowedCSRFprₙ,)

### (3) Margin

A margin can also be negotiated by a payer with contracted providers. Margins are added to the Adjusted Expected Typical costs for a provider by increasing that amount by the margin: MarginAdjEteₙprₙ=(1+Margin)*AdjEteₙprₙ

The total added margin should be reported by Provider, and understood by the payer to be a net additive cost of any patient-episode. Any offset would have to be negotiated between the payer and the provider, perhaps by selecting a higher target reduction in SRFs or Expected Complications. But these offsets would be solely the result of negotiations.

Total ECR Budget

Total ECR Budget=FinalAdjustedEteₙpₙ+FinalAdjustedEceₙpₙ

These calculations are to be translated at the patient level, so that every patient would have a full ECR budget. The SRF (system related failure) costs will be distributed as complication costs equally across all open episodes for the patient.

### Stoploss

In order to protect participating providers, a stoploss equation is provided for incorporation for when outlier actual costs are encountered during reconciliation.

The stoploss can be based on the standard deviation of average cost per PAC based on outputs from PAC Analysis. For Chronic/Other ECRs, the default stop loss can be set to 2 times the standard deviation. For Acute/Inpatient ECRs, the default stop loss can be set to 3 times the standard deviation. However, the stop loss, whether at the individual episode or in aggregate is ultimately determined by the payer/provider contracts and should be a modifiable field.

The terms and conditions of a stop loss must be reflected in the budget calculations. Since budgets are calculated based on historical data, the user cannot budget based on the full picture of claims history and pay based on a portion of that picture. For example, if a site is contracting for total knee replacement and the stop loss is set at $75,000—the user must exclude any costs above $75,000 from the historical data in order to calculate the predicted budgets. If not, the payer is artificially inflating the average episode cost and reducing the negative risk born by the provider.

### Budget Reconciliation

The prospective budgets and actual cost accumulation will be reconciled at the end of the established time period (e.g. year).

For each patient, the actual amounts spent during the episode will be compared to the prospective budget that is based on previous risk factors in order to create variance reports. The variance report will show if the actual spend is under or over budget, or over the stop-loss.

1. A computer implemented method for constructing a patient-specific evidence-informed case rate (ECR) for an episode of medical care spanning a defined period of time for a particular payer-provider-patient triad to create a patient-specific, severity adjusted prospective budget for the patient, the method comprising:
A. a processor, and
B. a memory coupled to the processor and having program instructions stored therein, the processor being operable to execute the program instructions, the program instructions including:
1) providing a first interface operation for calculating cost of care of a patient first specific episode by assigning services to each episode;
2) providing a second interface operation for segregating routine services from services associated with a complication for episode;
3) providing a third interface operation for defining services and patient episodes that are clinically related to the first episode;
4) providing a fourth interface operation for grouping additional patient specific episodes that are clinically related to the patient first specific episode;
5) providing a fifth interface operation for attributing the first episode and the additional patient specific episodes that are clinically related to the patient first specific episode to a specific health care provider;
6) providing a sixth interface operation for risk adjusting based on a performance measurement of said health care provider; and
7) providing a seventh interface operation for constructing a patient-specific prospective budget based on steps 1-6 for payment purposes.

2. A computer implemented method for constructing a patient-specific evidence-informed case rate (ECR) for an episode of medical care spanning a defined period of time for a particular payer-provider-patient triad to create a patient-specific, severity adjusted prospective budget for the patient the method comprising:
A. a processor, and
B. a memory coupled to the processor and having program instructions stored therein, the processor being operable to execute the program instructions, the program instructions including:
1) providing a first interface operation to construct Episodes of Care;
2) providing a second interface operation for Filtering to ensure that only complete episodes of care and only episodes of care relevant to a particular population of individuals proceed to a severity and risk adjustment operation;
3) providing a third interface operation attributing Episodes of Care to a specific health care provider;
4) providing a fourth interface operation for performing the severity and risk adjustment;
5) providing a seventh interface operation for preparing patient-specific, severity adjusted prospective budget prospective budget based on steps 1-4.

3. The method of claim 2, wherein construction of Episodes of Care comprises applying Trigger Logic rules, Service Assignment and Determining levels of Association;
Wherein trigger Logic rules utilize episode construction rules to determine existence of episodes, establish episode start and end date, identify episodes having a close clinical relationship in order to construct a consolidated view.
Wherein Service Assignment comprises comparing diagnosis and procedure codes for the service with an episode definition table and a list of episodes open at the time of the service to determine which open episodes a service is part of; wherein for each service assignment determining whether the service is typical for the episode, is a complication or is typical with a complication.
Wherein determining levels of Association is based on the relationship between two episodes and wherein the two episodes coexist, with one being primary and other being subsidiary to the other provided their time windows overlap.

4. The method of claim 2 wherein filtering comprises using a filter module to employ filters selected from the group consisting of: age range, minimum and maximum episode costs, coverage/enrollment gap, episode completion; and diagnosis related groups (DRGs).

5. The method of claim 2 wherein a provider attribution module provides an interface for a user of the computer implemented method to select at least one of an attribution option selected from the group consisting of a forced attribution option, a semi forced attribution option; procedural options; acute options, and chronic/other condition option.

6. The method of claim 2 wherein a severity and risk adjustment module performs the following processes:
Assignment of costs; defining a model period, and creating a model to utilize in performing the severity and risk adjustment; wherein the severity and risk adjustment is utilized to create:
a severity-adjusted budget based on expected costs of typical services and complications based on split costs; and
a risk-adjusted measure reflecting performance of health care providers based on actual allowed amounts from claims

7. A method of constructing a create a patient-specific, severity adjusted prospective budget for a patient, wherein the budget is based on a patient-specific evidence-informed case rate (ECR) for an episode of medical care spanning a defined period of time for a particular payer-provider-patient triad, the method comprising:
1) Using a processor to construct an episode of care;
2) Using a processor to filter out noncomplete episodes and irrelevant episodes from the episodes of care;
3) Using a processor Attribute episodes to a specific provider;
4) Using a processor to perform a severity and risk adjustment step to allow for calculation of costs; and
5) Using a processor to create a prospective budget based on steps 1-4.
